(19) United States
(12) Patent Application Publication
(10) Pub. No.: US 2020/0329233 A1
(43) Pub. Date: Oct. 15, 2020

(54) Hyperdata Compression: Accelerating Encoding for Improved Communication, Distribution & Delivery of Personalized Content

(71) Applicants: Frank Nemirofsky, Alamo, CA (US); Ronald Miller, Farmington Hills, MI (US)

(72) Inventors: Frank Nemirofsky, Alamo, CA (US); Ronald Miller, Farmington Hills, MI (US)

(21) Appl. No.: 16/846,804

(22) Filed: Apr. 13, 2020

Related U.S. Application Data
(60) Provisional application No. 62/833,628, filed on Apr. 12, 2019.

(51) Int. Cl. H04N 19/105; H04N 19/157; H04N 19/176

(52) U.S. Cl. CPC H04N 19/105; H04N 19/176; H04N 19/157

(57) ABSTRACT

A system and method for coding, encrypting, and distributing personalized content with substantial improvements in perceptual quality while reducing coding times, file sizes for storage, bandwidth requirements for distribution and utilization. Incorporating feature selection, extraction, classification, detection, and attribution to facilitate authenticity, feature detection for multi-media communications, providing enhance encrypting and distributing of personalized content in for a myriad of application areas including, but not limited to, medicine, science, robotics. Artificial Intelligence, nanotechnology, quantum computing, biotechnology, the Internet of Things, The Network of Things, fifth-generation wireless technologies (5G), additive manufacturing/3D printing, fully autonomous vehicles, drones, digital education, personalized data, Smart Grids, Smart Cities, and Smart Venues.

### TECHNICAL FIELD

The present disclosure relates generally to a system and method for Coding, Encrypting, and Distributing personalized content with substantial improvements in perceptual quality while reducing coding times, file sizes for storage, bandwidth requirements for distribution and utilization. New methods incorporating feature selection, extraction, classification, detection, and attribution are disclosed and facilitate authenticity, feature detection for multi-media communications, providing enhance encrypting and distributing of personalized content in for a myriad of application areas including, but not limited to, medicine, science, robotics. Artificial Intelligence, nanotechnology, quantum computing, biotechnology, the Internet of Things, The Network of Things, fifth-generation wireless technologies (5G), additive manufacturing/3D printing, fully autonomous vehicles, drones, digital education, personalized data, Smart Grids, Smart Cities, and Smart Venues.

### BRIEF DESCRIPTION OF THE DRAWINGS

The embodiments herein may be better understood by referring to the following description in conjunction with the accompanying drawings in which like reference numerals indicate identically or functionally similar elements, of which:

FIG. 2 illustrates HyperData™ Sample Applications;

FIG. 3 illustrates HyperData™ Coding System Integration;

FIG. 4 illustrates HyperData™ Sample Coding—All About Compression;

FIG. 5 illustrates Group of Pictures;

FIG. 6 illustrates Compression Methodology;

FIG. 7 illustrates Sample Encoder with Rate Control;

FIG. 8 illustrates a Simplified Decoder;

FIG. 9 illustrates HyperData™ Unit;

FIG. 10 illustrates Coding Representation;

FIG. 11 illustrates Coding Unit Division;

FIG. 12 Intra & Inter-Prediction Coding Quad-Tree

FIG. 13 illustrates Relationship Between CU, PU, and TU;

FIG. 14 illustrates a Rate-Distortion Optimization (RDO) Methodology;

FIG. 15 illustrates a Codec Comparison;

FIG. 16 illustrates Rate Distortion Optimization (RDO);

FIG. 17 illustrates Feature-Based Coding Mode Architecture;

FIG. 18 illustrates Intra-Prediction Directions & Gradients;

FIG. 19 illustrates Intra-Prediction Mode Decision Architecture;

FIG. 20 illustrates Intra-Prediction Mode Decision Architecture with Saliency;

FIG. 21 illustrates Visual Perception and Saliency Model;

FIG. 22 illustrates a Cascading Decision Tree Structure;

FIG. 23 illustrates Inter-Prediction CU Saliency Partitioning;

FIG. 24 illustrates Graph-Based Image Segmentation FIG. 25 illustrates Feature Attribute Detection;

FIG. 26 illustrates Image and Video Feature Detection and Classification;

FIG. 27 illustrates an Enhanced Feature Set;

FIG. 28 illustrates Enhanced Feature Set Continued;

FIG. 29 illustrates a Deep Learning Network with Enhanced Feature Maps;

FIG. 30 illustrates Hardware and Software System;

### DETAILED DESCRIPTION

In signal processing, data compression, source coding, or bit-rate reduction involves encoding information using fewer bits than the original representation. Compression can be either lossy or lossless. Lossless compression reduces bits by identifying and eliminating statistical redundancy. No information is lost in lossless compression. Lossy compression reduces bits by removing unnecessary or less important information. The process of reducing the size of a data file is often referred to as data compression. In the context of data transmission, it is called source coding; encoding is done at the source of the data before it is stored or transmitted. Data compression is subject to a space-time complexity trade-off and this invention, coupled with the SmartPlatform™ and the One-Second-Gateway™, significantly improve the encoding, encryption, transmission, decoding, storage, and perceptual video quality experienced by the user.

Compression is useful because it reduces the resources required to store and transmit data. Computational resources are consumed in the compression process and, usually, in the reversal of the process (decompression). Data compression is subject to a space-time complexity trade-off [One Second Gate Way]. For instance, a compression scheme for video may require expensive hardware for the video to be decompressed fast enough to be viewed as it is being decompressed, and the option to decompress the video in full before watching it may be inconvenient or require additional storage. The design of data compression schemes involves trade-offs among various factors, including the degree of compression, the amount of distortion introduced (when using lossy data compression), and the computational resources required to compress and decompress the data.

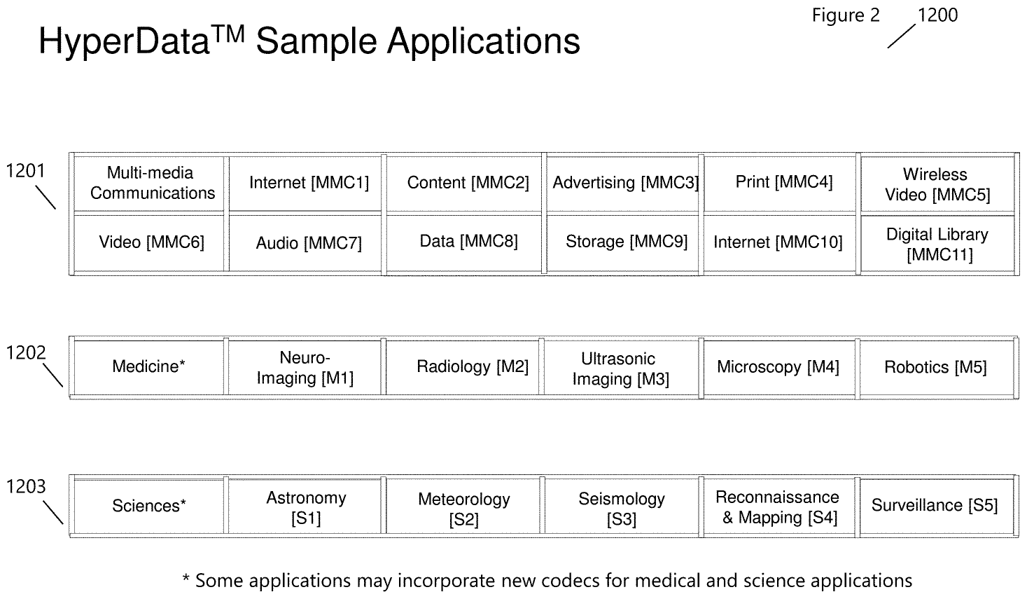

Compression techniques and application areas, as shown in FIG. 2 (1200), span a broad and diverse range including Multi-Media Communications (1201), Medicine (1202), and the Sciences (1203). Multi-Media communications ranges from, but is not limited to, the Internet (1201:MMC1), Content (1201:MMC2), Advertising (1201:MMC3), Print (1201:MMC4), Wireless Video (1201:MMC5), Video (1201:MMC6), Audio (1201:MMC7), Data (1201:MMC8), Storage (1201:MMC9), Internet (1201:MMC10), and Digital Libraries (1201:MMC11). Medical imaging and diagnostics have increased significantly over the past couple of decades and will continue to increase in the advent of 3D-4D imaging, bioinformatics, and nanotechnologies. Storage and analyses, coupled with image preprocessing, feature creation, extraction, and detection require new methods that work in concert with the medical professions providing associated perceptual queues, classification, and naming. HyperData™ Medicine (1202) applications range from Neuro-Imaging (1202:M1), Radiology (1202:M2), Ultrasonic Imaging (1202:M3), Microscopy (1202:M4), and Robotics (1202:M5). The Sciences (1203) have a similar need in image compression, processing, analysis, and storage including Astronomy (1203:S1), Meteorology (1203:S2), Seismology (1203:S3), Reconnaissance & Mapping (1203:S4), and Surveillance (1203:S5).

With the increasing user demand for high-quality video, and the proliferation of consumer electronic devices with a variety of resolutions, consortiums have been working in creating new standard aimed at improving the coding and delivery of media to consumers. The demand for Multi-Media Communications (1200) will only increase in time, requiring inventive solutions. Some leading compression codecs, aimed at addressing the present multi-media needs, are HEVC (High-Efficiency Video Coding), H.264/MPEG-2 (Moving Pictures Expert Group), and VP9. HEVC is developed by the Joint Collaborative Team on Video Coding (JCTVC), whose coding efficiency performs almost two times that of the H.264 standard. Another state-of-art one developed by Google is called VP9 codec, which is an open and royalty-free video coding format, developed by Google. Both HEVC and VP9 involve more sophisticated coding features and techniques than the previous coding standards. HEVC and VP9 introduce larger Coding Units (CUs) supporting larger resolution. HEVC introduces a more flexible hierarchical-block based coding unit (CU) designed with quadtree partitions and higher depth levels, together with prediction unit (PU) and transform unit (TU) [described below].

Higher coding efficiencies [e.g., HEVC, V9], as compared to older standards [MPEG-2, H.262] incorporate video code standards with key features, supporting different architectures and error resilience tools. The new coding tools enhance the rate-distortion efficiencies while increasing the encoding complexity. Generally speaking, the rate-distortion (RD) performance can be optimized with a mode choice whose Lagrangian RD cost is minimized; however, the selection of the optimal modes is not trivial and results in a large computational cost. The RDO algorithm calculates the rate-distortion cost (RD) of each coding blocks with respect to each macroblock [e.g., H.264/AVC] and chooses the coding mode with the lowest rate-distortion cost. As the number of blocks increases, as in the case of HEVC (described above), increased optimization processing is required in order to find computationally feasible compression with acceptable space encoding and decoding times.

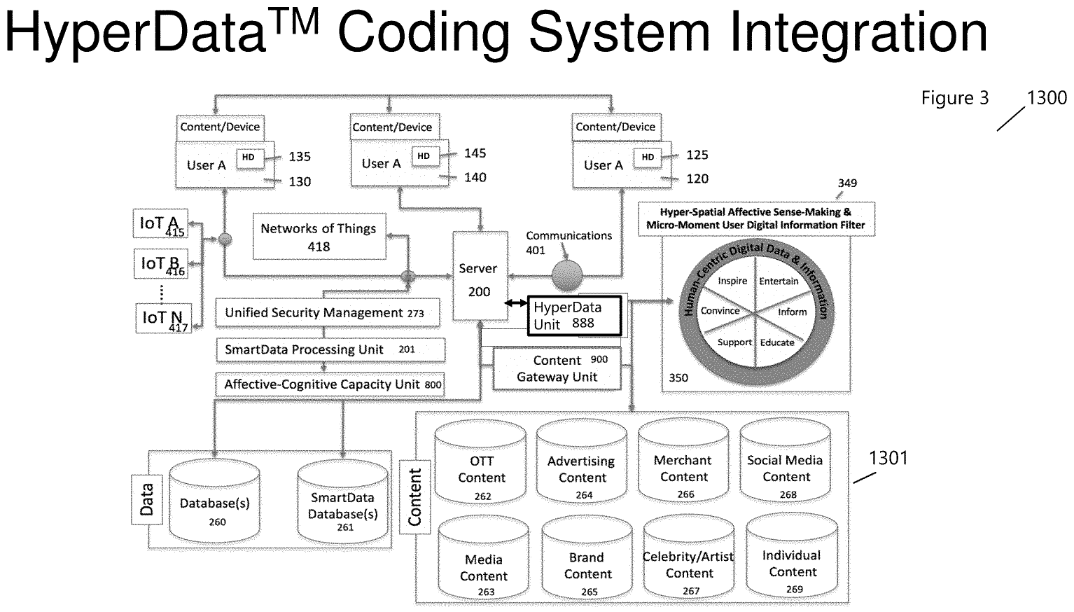

Video, image, and data compression methods impact storage and transmission of content and depend on the available storage, bandwidth, processor speed, display properties, content format, type and more. As was stated above, Rate Distortion calculations are performed across multi-steam content with the aim of providing the best delivery and consumer experiences. The Hyperdata™ Coding System Integration (FIG. 3 1300) details the integration of the Hyperdata™ Unit (888), into the SmartPlatform™ with the Content Gateway Unit™ (utilizing One-Second-Gateway™: 900). The Hyperdata™ Unit (888) can be utilized within any architecture; however, when utilized within the SmartPlatform™ transmission and storage complexity are reduced, providing a unique, personalized and individualized experience throughout the Hyperdata™ Application Areas (FIG. 2, 1201,1202, and 1203 for example). This is accomplished in part by SmartMedia™ that integrates patented encoded and encrypted information into data, information, images, and or videos. The SmartMedia™ information is decoded at the end-point of transmission such as on a smart display through varied human-interface-technologies (e.g., voice, touch, haptic, motion, cognitive, muscular and more), providing additional information, content, and advertising offers, discounts, trials and more based upon the user's profiles (AdPlexing™; including enterprises and individuals).

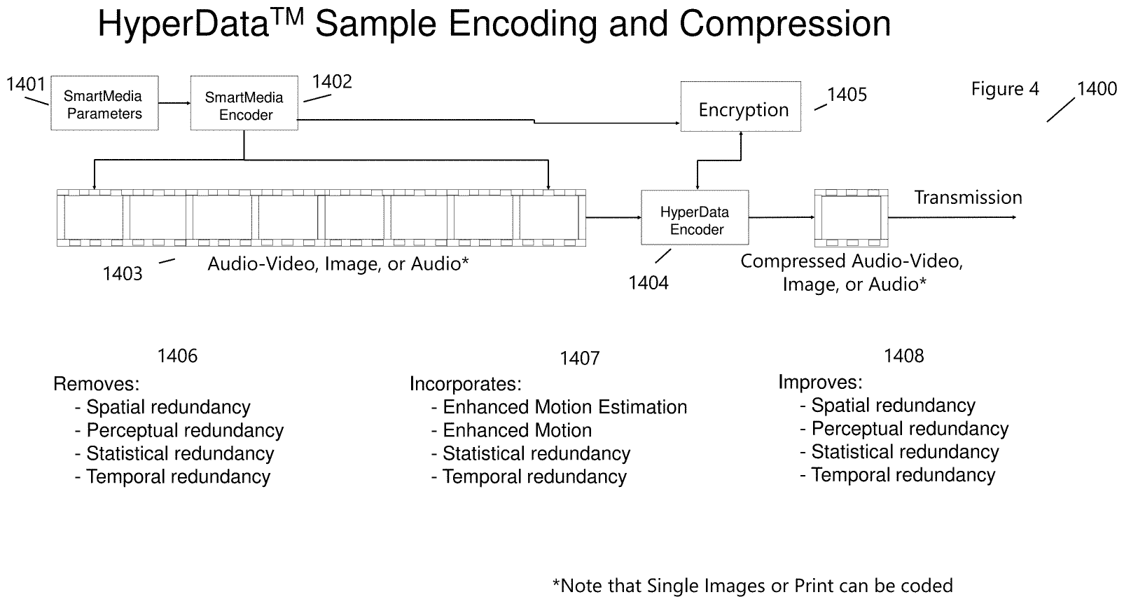

FIG. 4 (1400) shows a sample HyperData™ Sample Encoding Compression and is utilized within the HyperdataTMCoding System (1300). SmartMedia™ parameters (1401) are combined with SmartMedia™ encoder to embedded information within audio, video, images, print and more. The SmartMedia™ parameters include, but are not limited to, an individual's SmartData™ (FIG. 3, 261), smart devices, including IoT (FIG. 3, 415-417) and Networks of Things™ (FIG. 3, 418), and encoder specifics. The encoding process (1402), as described in the Ribbon™ and AdPlexing™, is capable of encoding varied information within a diverse content landscape (e.g., text in (print, audio, images, videos)). This manner of encoding allows for the concealment of personalized information, which is content and context specific, being delivered to an individual's smart device. The SmartMedia™ parameters (1401) also the specify time, duration, region, location, and more of how the content is to be encoded throughout the media that is then delivered to the HyperData™ Encoder (1404). Encryption (1405) type, level, and configurations (e.g., ATSC 1,2,3 or ISMACryp, DVB, DVB-H, DMB, etc.) used by the encoder (1404) to encrypt the information before transmission. The compression is obtained through the Encoder (1404) which Removes (1406) and Improves (1408) redundancy and Incorporates (1407) motion estimation and compensation.

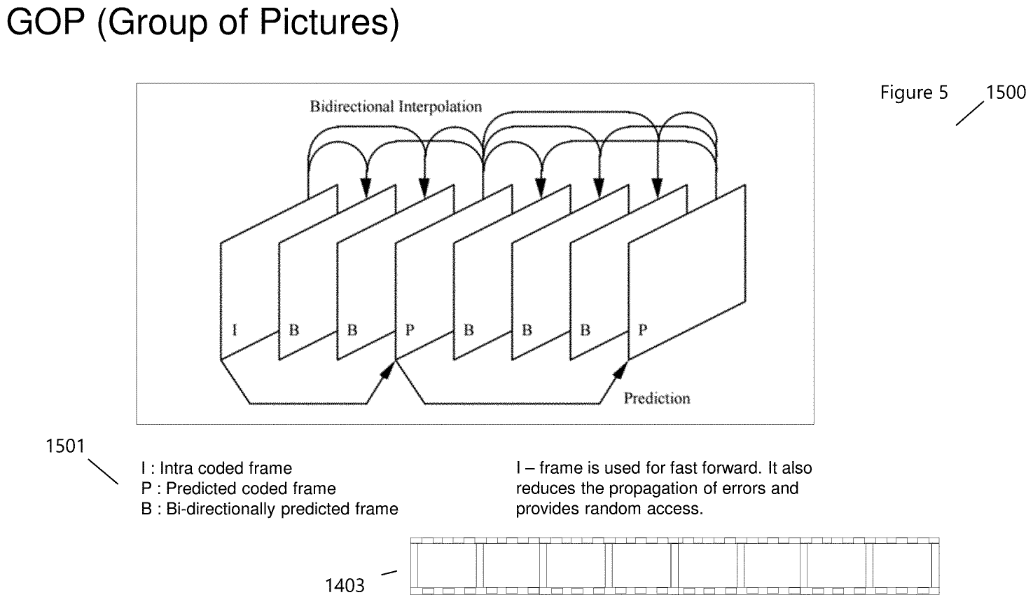

Videos can be considered a group of frames that have a particular frequency or framerate. FIG. 5 shows a Group of Pictures (GOP) that collectively equate to a video as shown in FIG. 4 (1403). In order to deal with transmission noise and bandwidth limitations, compression and redundancy reduction techniques (e.g., as described in FIG. 4 (1400)) are used with varying coding schemes, resulting in sequential or non-sequential frames that are decoded and combined in order to re-create the original video. Three principal frame types (1501) used in mode designs are used for multi-media video transmission are Intra-Coded (I-frames), Predicted-Coded (P-frames), and Bi-Directional Predicted (B-frames). The reference frame is known as intra-frame, which is strictly intra-coded, so it can always be decoded without additional information. In most designs, there are two types of inter frames: P-frames and B-frames. The difference between P-frames and B-frames is the reference frame they reference. P-frames are Predicted-pictures made from an earlier picture (i.e., an I-frame), requiring fewer coding data (≈50% when compared to I-frame size). The amount of data needed for doing this prediction consist of motion vectors and transform coefficients describing prediction correction referred to as motion compensation. B-frames are Bidirectionally-predicted pictures. This type of prediction method occupies fewer coding data than P-frames (≈25% when compared to I-frame size) because they can be predicted or interpolated from an earlier and/or later frame. Similar to P-frames, B-frames are expressed as motion vectors and transform coefficients. In order to avoid a growing propagation error, B-frames are not used as a reference to make further predictions in most encoding standards. However, in newer encoding methods B-frames may be used as a reference.

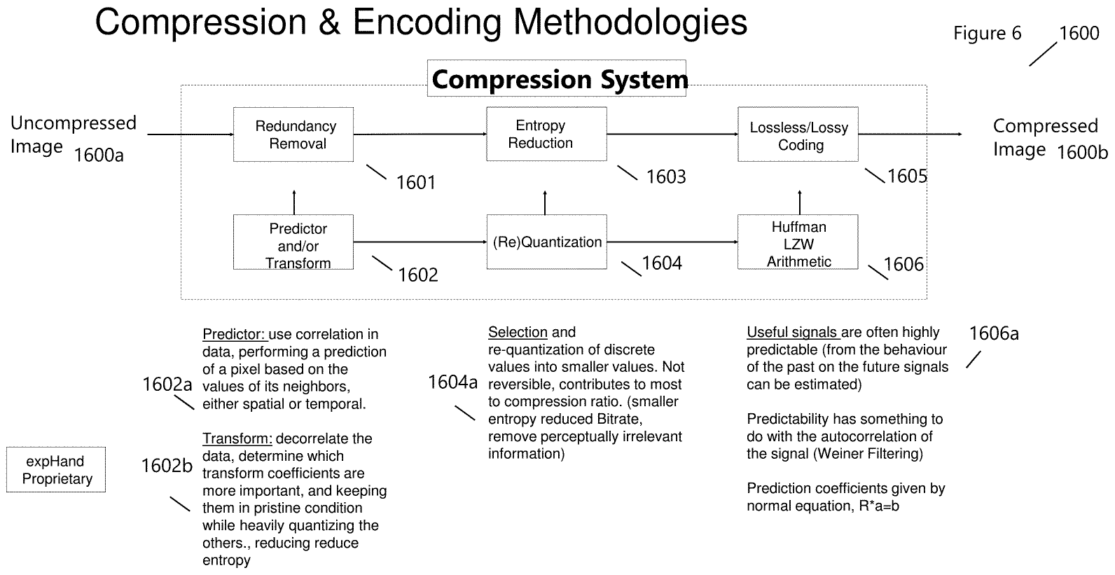

FIG. 6 (1600) shows a representative compression and encoding methodology that starts with an uncompressed image (1600a) and ends with a compressed image (1600b) as output. The design of data compression schemes involves trade-offs among various factors, including the degree of compression, the amount of distortion introduced (when using lossy data compression), and the computational resources required to compress and decompress the data. Improving the encoding Lossless data compression algorithms usually exploit statistical redundancy to represent data without losing any information, so that the process is reversible. Lossless compression is possible because most real-world data exhibits statistical redundancy. The Lempel-Ziv (LZ) compression methods (1606) are among the most popular algorithms for lossless storage. LZ methods use a table-based compression model where table entries are substituted for repeated strings of data. For most LZ methods, this table is generated dynamically from earlier data in the input which is itself often Huffman encoded. The strongest modern lossless compressors use probabilistic models, such as prediction by partial matching. Statistical estimates using probabilistic modeling can be coupled to an algorithm called arithmetic coding. Arithmetic coding (1606) is a more modern coding technique that achieves superior compression compared to other techniques. An early example of the use of arithmetic coding was in JPEG image coding standard. It has since been applied in various other designs including H.263, H.264/MPEG-4 AVC and HEVC for video coding.

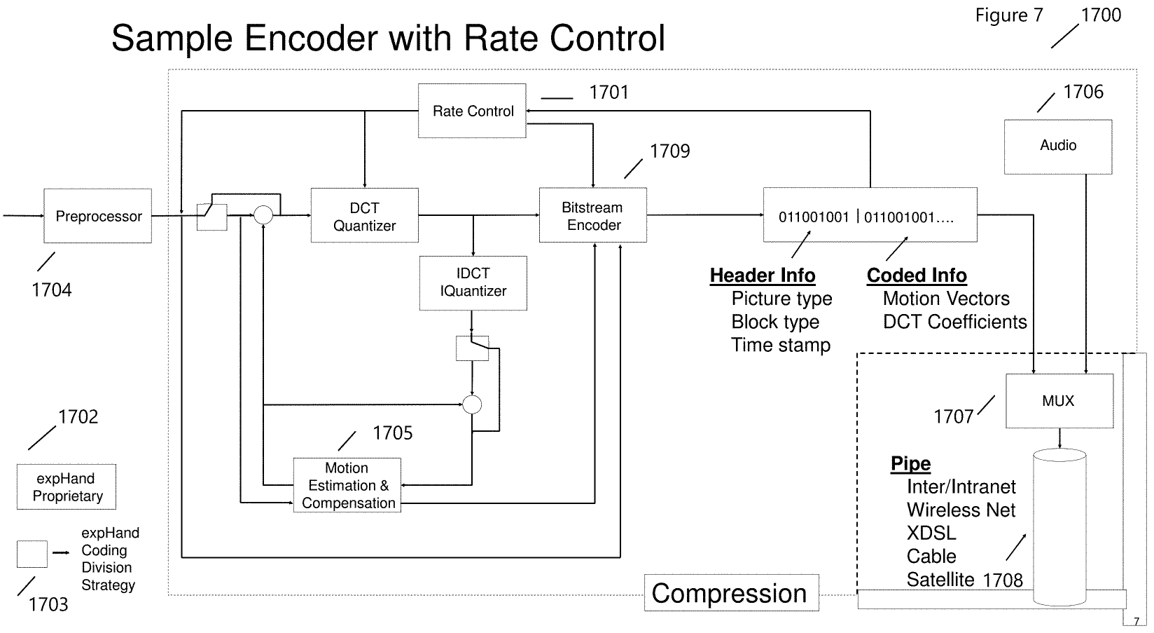

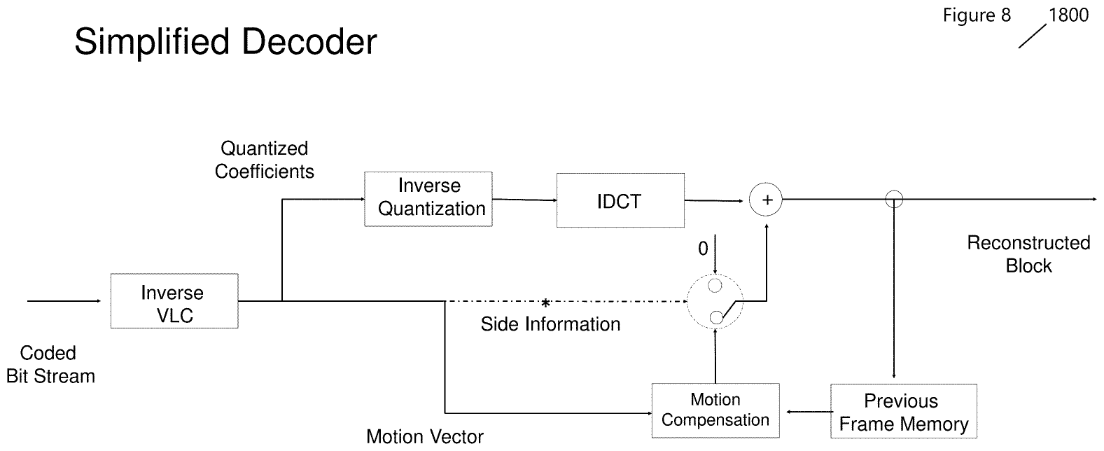

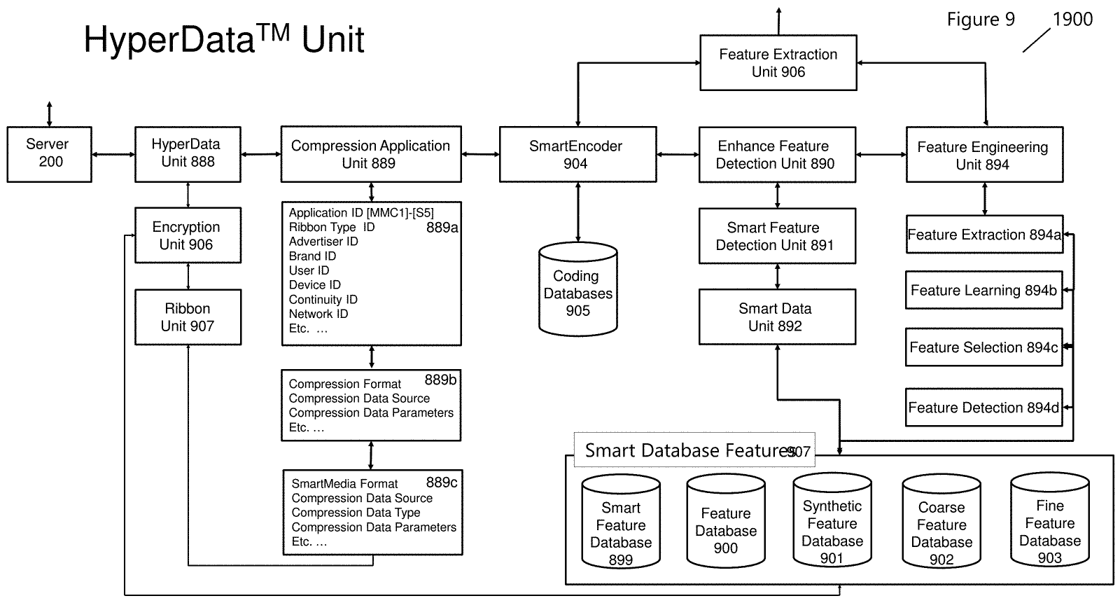

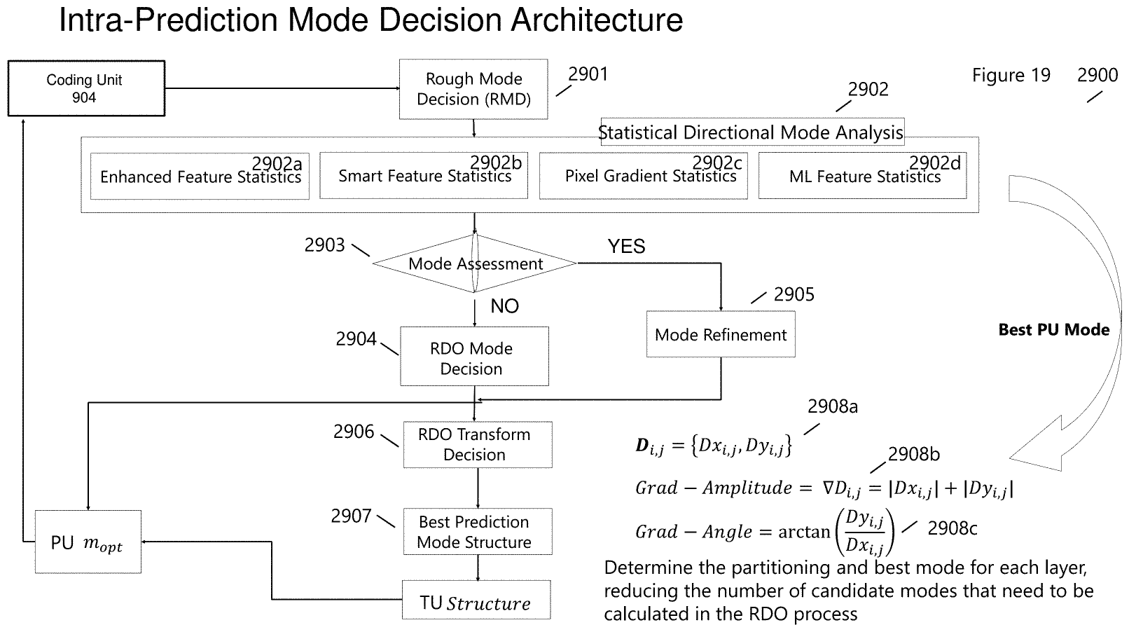

FIG. 7 (1700) details a further complication encountered when video transmission is needed. The parameters and methods outlined in FIG. 6 (1600; Compression & Encoding Methodologies) are dynamical when considering video coding and transmission of content and inevitably the decoding process for video entertainment or analysis (e.g., distance medical treatment, education, etc.). In order to limit the amount of data transmitted over the communications channel, differential information is transmitted that reference changes relative to a previous or Intra-Coded frame as exemplified in FIG. 6. Preprocessing (1704), Motion Estimation & Compensation (1705), Coding Control (1703), and Rate Control (1701) are used to determine the appropriate quantization, bitrate, and distortion of the resulting video transmission (FIG. 9, 1900). The Preprocessor (1704) utilizes image feature selection, extraction, detection, and classification (Figures x), which supports the Coding Strategy (1703) and Rate Controller (1701). Intra-Coded frames skip the motion estimation & compensation and pass directly to and through the Bitstream encoder, combined with header information and more. Frames requiring motion estimation (e.g., regions of feature complexity or movement) are differenced in time from the previous image, quantized then sent to the bitstream encoder. Quantization changes and motion vector calculations are performed to deliver the best image quality (low distortion), for a given bitrate and quantization, which is controlled by the Rate Control (1701) [FIG. 19 demonstrates quantization parameters that vary dependent on salient features which are determined through Preprocess]. Combined with header information, these frames are multiplexed (1707) with Audio (1706) and delivered across a communication channel (1708) [include FIG. 19 QP values]. FIG. 8 (1800) shows a Simplified Decoder which reverses the encoding process and reconstructs the frame or blocks. The Decoder (1800) is utilized within the encoder to determine the resulting video received by the user.

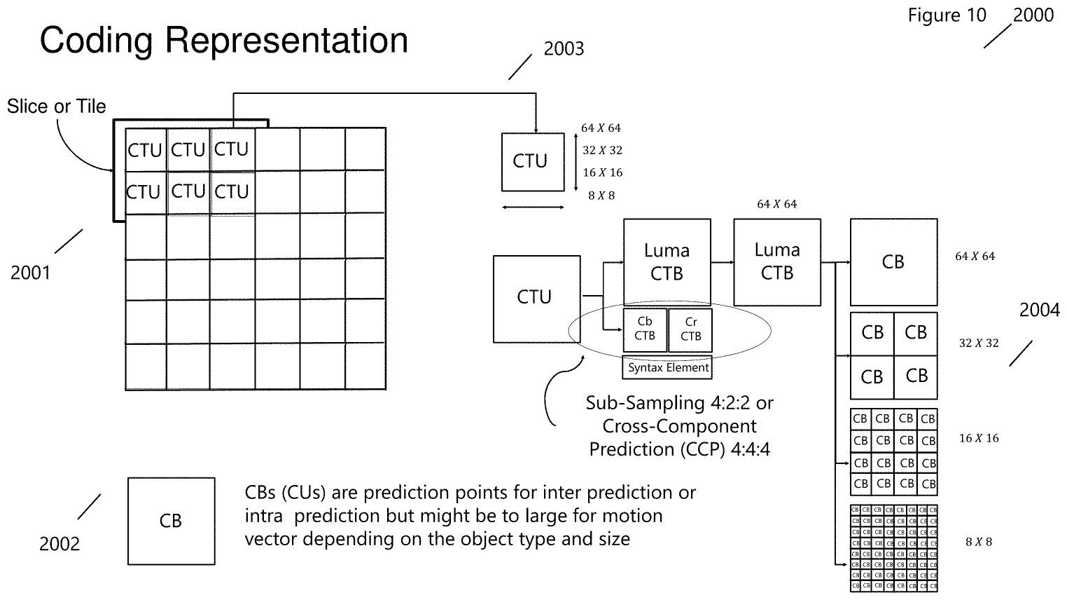

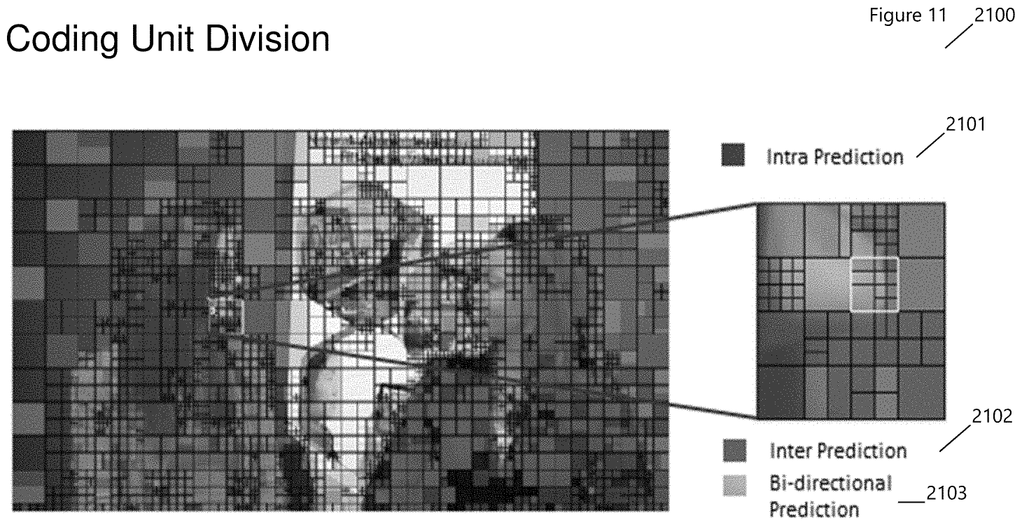

FIG. 9 (1900) displays the Hyperdata™ Unit (888) that is integrated into the SmartPlatform™ shown in FIG. 3 (1300; Hyperdata™ Coding System Integration). Server 200 communicates Hyperdata™ parameters including all-media and or content to the Compression Application Unit (889). Application specific information, as described in FIG. 2 (1200) from 1200:MMC1 to 1203:S5, include 889a [e.g., Application ID, Ribbon Type ID, Advertiser ID, Brand ID, User ID, Device ID, Continuity ID, Network ID, and more], 889b [Compression Format, Compression Data Source, Compression Data Parameters, and more], and 889c [SmartMedia Format, Compression Data Source, Compression Data Type, Compression Data Parameters, and more]. The SmartEncoder (904) receives control parameters from 889 while accessing previous coding databases (905). Coding databases provide speed, flexibility, and accuracy in determining the appropriate coding parameters and procedures for the Hyperdata™ application. The SmartEncoder (904) can be used to for Feature Engineering (894) and Feature Extraction (906) for various Hyperdata™ Application (MMC1-S5). The Feature Engineering Unit (894) combines Feature Extraction (894a), Feature Learning (894b), Feature Selection (894c), and Feature Detection (894d) that all utilize unique database features that incorporate scale (e.g., Coarse Feature Database (902) and Fin Feature Database (903)), synthetic (Synthetic Feature Database (901), Smart Feature Database (899), and more. The Enhanced Feature Detection (890), used by SmartEncoder (904), determines the appropriate coding unit selection and depth FIG. 10 (2000) shows a Coding Representation used to divide a video or image frame into manageable Coding Blocks (CBs) or Coding Units (CUs). An HEVC CU is similar to the concept of H.264 MacroBlock (MB) but varies from 64×64 pixels to 8×8 pixels in possible sizes. Slices or Tiles (2001) are used to group sections of CUs together for processing, and for the convenience of this discussion, FIG. 10 only displays Coding-Tree-Units (CTUs). Each CTU contains a Luma (Intensity) and Chrominance (Color) block, with sub-sampling for Chrominance that is performed to reduce bandwidth and storage, removing perceptually insensitive data. Each block is sub-divided (2004) into smaller blocks (i.e., a quad-tree structure) depending on the block complexity and represent points of inter-prediction or intra-prediction. FIG. 11 (2100) displays a frame image that incorporates multiple blocks and Coding Prediction Units (PU) (e.g., I-Coding, P-coding, and B-Coding). From FIG. 11, a finer resolution or quad-tree depth is used for regions of complexity, boundaries, or for objects where motion dominates the edge evolution of the object within the context of the frame, image, or video. Determining this level of depth is accomplished through the Hyperdata™ Unit (888), and from Coding Division (1703), and the Rate Control (1701).

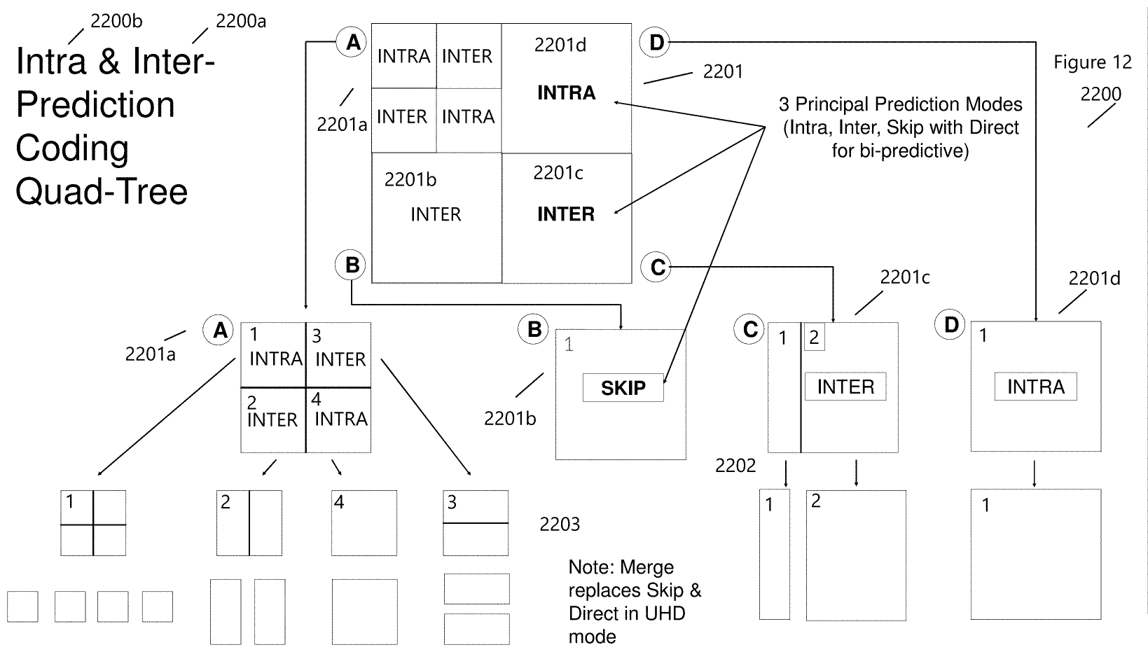

A CU as shown in FIG. 12 (2201) is recursively split into four CUs up to the maximum allowable hierarchical depth. At the maximum depth, the CU forms a leaf-node that cannot be sub-divided. The resulting CU is then encoded with one of the following modes: (1) MERGE/SKIP, (2) Inter_2N×2N, (3) Inter_2N×N, (4) Inter_N×2N, (5) Asymmetric Motion Partition (AMP) and (6) Intra_2N×2N modes). The original CU (2201) is sub-divided into 4 sub-blocks of varying the relative size. The first block A (2201a) includes two different types of modes Intra and Inter, which are subsequently divided into smaller blocks (2203) with different resolution. Block 1 Intra (2203) is subdivided equally however block 4 Intra (2203) retains its original resolution. The Inter-Blocks in (2203) can be sub-divided asymmetrically offering enhanced capability in predicting motion vectors. MERGE/SKIP (2201b) modes decrease coding times due to requiring less computational resources to further sub-divide and rate-distortion optimization calculations. Block C (2201c) and D (2201d) show similar evolution as previously discussed.

Inter-frame coding (2200a) works by comparing each CU or frame in a video with the previous one. Individual frames of a video sequence are compared from one frame to the next, and the video compression codec sends only the differences to the reference frame (residual). If the frame contains areas where nothing has moved, the system can simply issue a short command that copies that part of the previous frame into the next one. If sections of the frame move in a simple manner, the compressor can emit a (slightly longer) command that tells the decompressor to shift, rotate, lighten, or darken the copy. This longer command still remains much shorter than intraframe compression. Usually, the encoder will also transmit a residue signal which describes the remaining subtler differences to the reference imagery. Using entropy coding (FIG. 7, 1709), these residue signals have a more compact representation than the full signal. In areas of video with more motion, the compression must encode more data to keep up with the larger number of pixels that are changing.

These high-frequency detail can lead to a decrease in quality or an increase in the variable bitrate. An inter-coded frame is divided into blocks known as macroblocks or CTU (2001) depending on the codec. Instead of directly encoding the raw pixel values for each block, the encoder will try to find a block similar to the one it is encoding on a previously encoded frame, referred to as a reference frame. This process is done by a block matching algorithm. If the encoder succeeds on its search, the block could be encoded by a vector, known as a motion vector, which points to the position of the matching block at the reference frame. The process of motion vector determination is called motion estimation. In most cases, the encoder will succeed, but the block found is likely not an exact match to the block it is encoding. This is why the encoder will compute the differences between them. Those residual values are known as the prediction error and need to be transformed and sent to the decoder. Inter-prediction has some potential issues that affect may fail to either (1) find a suitable match leading to a motion vector that has a greater prediction error and signal degradation (without suitable iteration and modification), or (2) propagate errors from one frame to the next, without the ability to determine the degradation from the previous frames.

Intra-frame coding (2200b), however, is used in video coding (compression). Intra-frame prediction exploits spatial redundancy, i.e. correlation among pixels within one frame, by calculating prediction values through extrapolation from already coded pixels for effective delta coding. It is one of the two classes of predictive coding methods in video coding. Its counterpart is inter-frame prediction which exploits temporal redundancy. Temporally independently coded intra frames use only intra-coding. The temporally coded predicted frames (e.g. MPEG's P- and B-frames) may use intra- as well as inter-frame prediction (FIG. 5, 1500). Only a few of the spatially closest samples are used for the extrapolation such as the four adjacent pixels (above, above left, above right, left) or some function of them like e.g. their average. Block-based (frequency transform) formats prefill whole blocks with prediction values extrapolated from usually one or two straight lines of pixels that run along their top and left borders. The term intra-frame coding refers to the fact that the various lossless and lossy compression techniques are performed relative to information that is contained only within the currentframe, and not relative to any other frame in the video sequence. In other words, no temporal processing is performed outside of the current picture or frame. Non-intra coding techniques are extensions to these basics.

There are two mainstream techniques of motion estimation: Pel-Recursive Algorithm (PRA) and Block-Matching Algorithm (BMA). PRAs are iterative refining of motion estimation for individual pixels by gradient methods and involve more computational complexity with less regularity, making the realization in hardware difficult. BMAs assume that all the pixels within a block have the same motion activity, producing one motion vector for each block that rectangular in nature. The underlying supposition behind motion estimation is that the patterns corresponding to objects and background, in a frame of a video sequence, move within the frame to form corresponding objects on the subsequent frame. This can be used to discover temporal redundancy in the video sequence, increasing the effectiveness of inter-frame video compression, by defining the contents of a macroblock (or CU) by its reference to the contents of a known macroblock (or CU) that is minimally different.

A block matching algorithm involves dividing the current frame of a video into macroblocks (or CUs) as demonstrated in FIG. 10 (2003) and comparing each of the macroblocks (or CUs) with a corresponding block to its adjacent neighbors in a nearby frame of the video (sometimes just the previous one). A vector is created that models the movement of a macroblock from one location to another. This movement, calculated for all the macroblocks (or CUs) comprising a frame, constitutes the motion estimated in a frame. The search area for a good macroblock (or CUs) match is decided by the ‘search parameter’, ρ, where ρ is the number of pixels on all four sides of the corresponding macro-block in the previous frame. The search parameter is a measure of motion. The larger the value of ρ, the larger is the potential motion and the possibility of finding a good match. A full search of all potential blocks, however, is a computationally expensive task. Typical inputs are a macroblock of size 16 pixels (or 64 pixels maximum for CUs) and a search area of ρ=7 pixels.

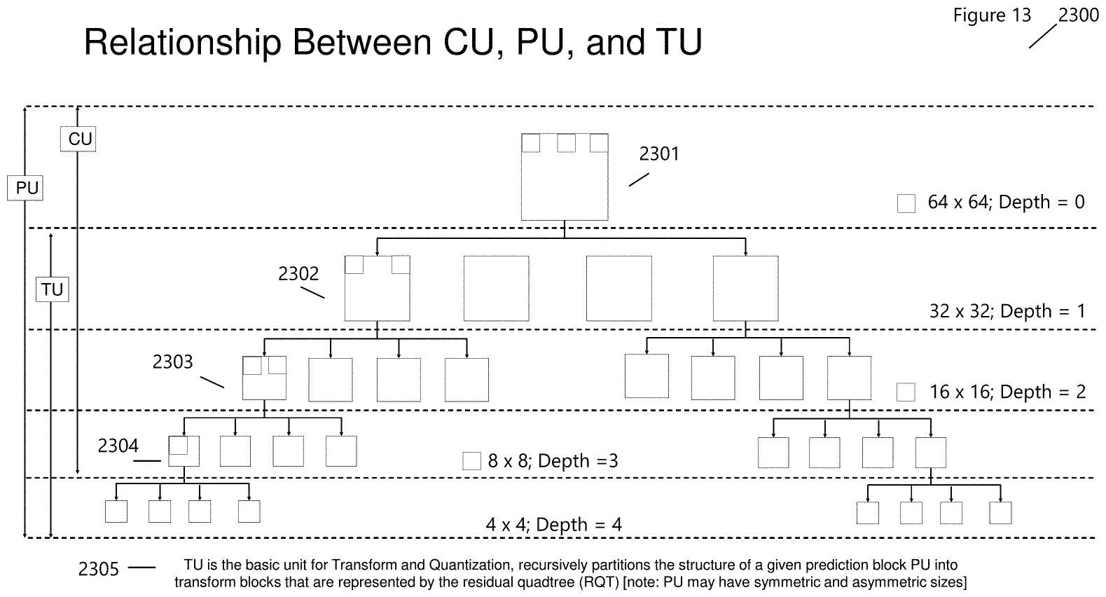

FIG. 13 (2300) shows the coding unit partitioning in more detail. New coding stands incorporate flexible hierarchical block structures with quadtree partitions and higher depth are adopted, which are composed of Coding Unit (CU), Prediction Unit (PU) and Transform Unit (TU). The CU is a basic processing unit for encoding and decoding, which includes motion estimation (ME)/motion compensation (MC), transform, quantization and entropy coding as shown in FIG. 7 (1700). The CU with the maximum size is called the largest CU (LCU) and its size and the number of predefined depths is signaled in a sequence level. The initial depth (D_{Th}=) starts at 64 pixels×64 pixels whereby D_{Th}={1,2,3,4}, corresponding to CUs with {32×32, 16×16, 8×8, and 4×4} pixels shown in FIG. 13 (2300). CUs and PUs have a similar depth architecture (aside from an asymmetric PU resolution); however, the TUs are typically one depth level larger (D_{T}h+1). The PU performs both the ME and MC, whose block sizes include 2N×2N, 2N×N and N×2N for the 2N×2N as shown in FIG. 12 (2200) and FIG. 13 (2300). The block sizes of TU range from 32×32 p to 4×4 pixels and result in a quadtree structure for the TU made at the leaf node of the Coding Units. CUs are hierarchically partitioned in an LCU, which functions similarly as an MB in H.264/AVC. PU performs ME and MC to produce the residual signal with various prediction block sizes. Then, for the obtained residual signal, transform and quantization are performed in the TU block. The HEVC adopts significantly different coding structures compared to the H.264/AVC, which is known as the video coding standard with the highest coding efficiency

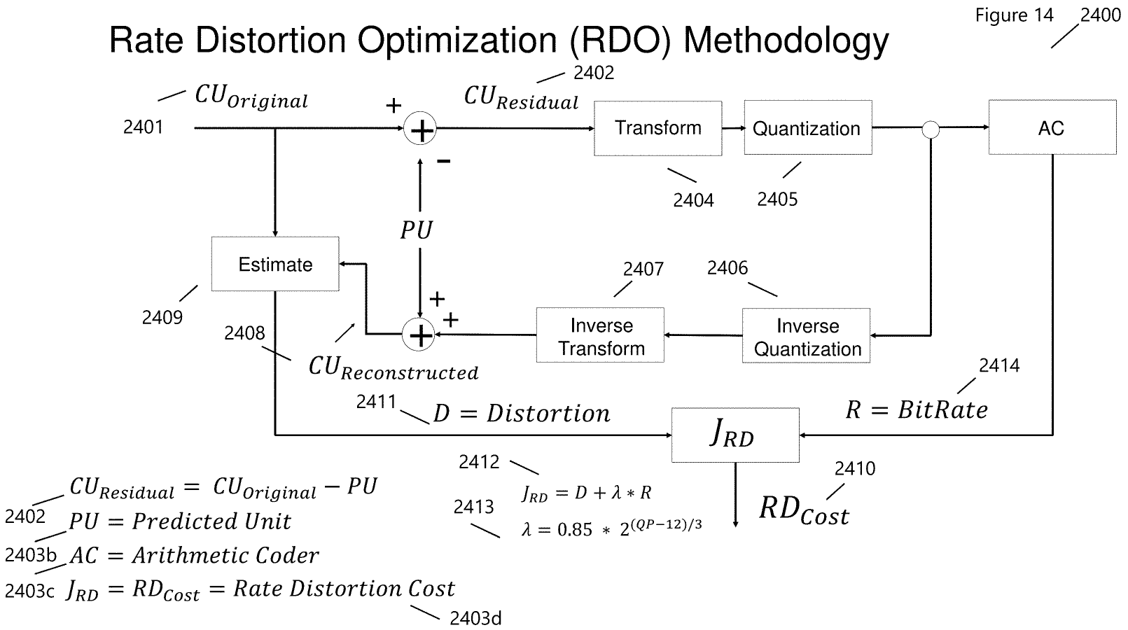

To find the optimal combination of CUs, PUs, and TUs, a full search of all potential CUs whose cascading structure provides the best compression and subsequent transmission while minimizing the information loss. This complicated and computationally expensive procedure is accomplished by optimizing the of the Rate-Distortion (RD) costs shown in FIG. 14 (2400). The Rate-Distortion Optimization (RDO) is performed over all CUs. The name refers to the optimization of the amount of distortion (loss of video quality) against the amount of data required to encode the video, the rate. FIG. 14 (2400) shows the RDO Methodology which is used on each CU described in FIGS. 12 (2200) and 13 (2300). RDO is used to improve quality in any encoding situation (image, video, audio, or otherwise) where decisions have to be made that affect both file size and quality simultaneously, as is the case of lossy video transmissions.

As described in FIG. 7 (1700), each sequential image (i.e., t₁=t₀+δt) is compared to a previous image in the series (i.e., to). This differential information CU_{Residual} (2402), or residual, is then Transformed (T: 2404) and Quantized (Q: 2405), whose data is then processed by a bitstream encoder (i.e., 2403b Arithmetic Coder). An Inverse Quantization (IQ: 2406) and Transform (IT: 2407) of the data stream is combined with the original CU_{Original} and results in a reconstructed coding unit CU_{Residual} (2408) that Estimates (2409) the impact of Q & T process. The resulting Distortion (D: 2411) is measured by comparing the original and reconstructed CUs or MBs. Rate-distortion optimization measures both the deviation from the source material (D:2411) and the bit cost (R: 2414) for each possible decision outcome. R represents the total bits for the CU/MB header, motion vectors, and DCT coefficients (Discrete Cosine Transform from T). The bits are mathematically measured by multiplying the bit cost R (2414) by the Lagrangian A (2413), a value representing the relationship between bit cost and quality for a particular quality level (Quantification Parameter, QP, with {QP: 22, 27, 32, 37,42, 47, etc.}). Solving this system of equations, with constraints in acceptable distortion levels (D), bitrate levels (R), or quantization (QP), delivers the resulting compression and transmission of data (1700), as reversed by the decoder (1800), and viewed by the user (130).

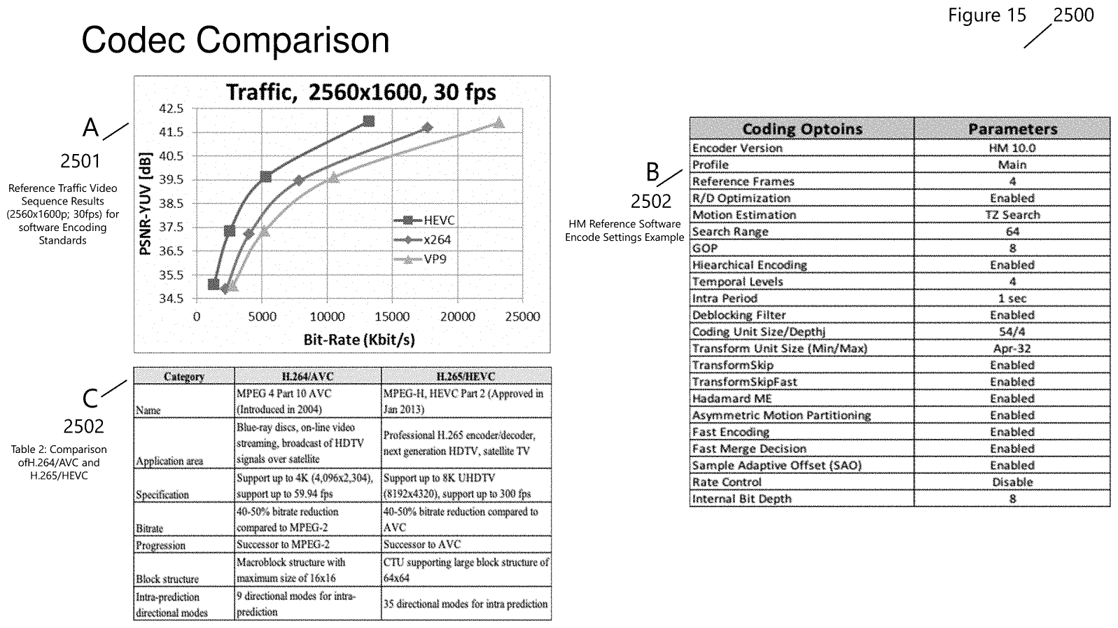

FIG. 15 (2501) and Table C (2502) shows the improvements in compression utilizing the standard traffic sequence for three compression codecs: HEVC (High-Efficiency Video Coding), H.264/MPEG-2 (Moving Pictures Expert Group), and VP9. HEVC is developed by the Joint Collaborative Team on Video Coding (JCTVC), whose coding efficiency performs almost two times that of the H.264 standard. Another state-of-art one developed by Google is called VP9 codec, which is an open and royalty-free video coding format, developed by Google. Both HEVC and VP9 involve more sophisticated coding features and techniques than the previous coding standards. In HEVC, more flexible hierarchical-block based coding unit (CU) is designed with quadtree partitions and higher depth levels (FIGS. 10 [2001, 2003, 2004], 11 [2101, 2102, 2103], 12 [2201c, 2201d], and 13 [2301-2304]). FIG. 15 B (2502) displays an example of the HEVC Mode (HM) reference software used for encoding. Multiple parameters are used to determine how to encode a video sequence and are transmitted to the decoder as part of the communications header information.

The deviation from the source is usually measured as the mean squared error, in order to maximize the PSNR video quality metric. Peak signal-to-noise ratio, often abbreviated PSNR, is an engineering term for the ratio between the maximum possible power of a signal and the power of corrupting noise that affects the fidelity of its representation. Because many signals have a very wide dynamic range, PSNR is usually expressed in terms of the logarithmic decibel scale and is most commonly used to measure the quality of reconstruction of lossy compression codecs (e.g., for image compression). The signal, in this case, is the original data, and the noise is the error introduced by compression. When comparing compression codecs, PSNR is an approximation to the human perception of reconstruction quality. Although a higher PSNR generally indicates that the reconstruction is of higher quality, in some cases it may not. FIG. 15 A (2501) shows that for a fixed bitrate, the higher PSNRs are obtained through the use of new standards and quad-tree coding units. Similarly, for a fixed PSNR value, less bandwidth is required for the newer standards.

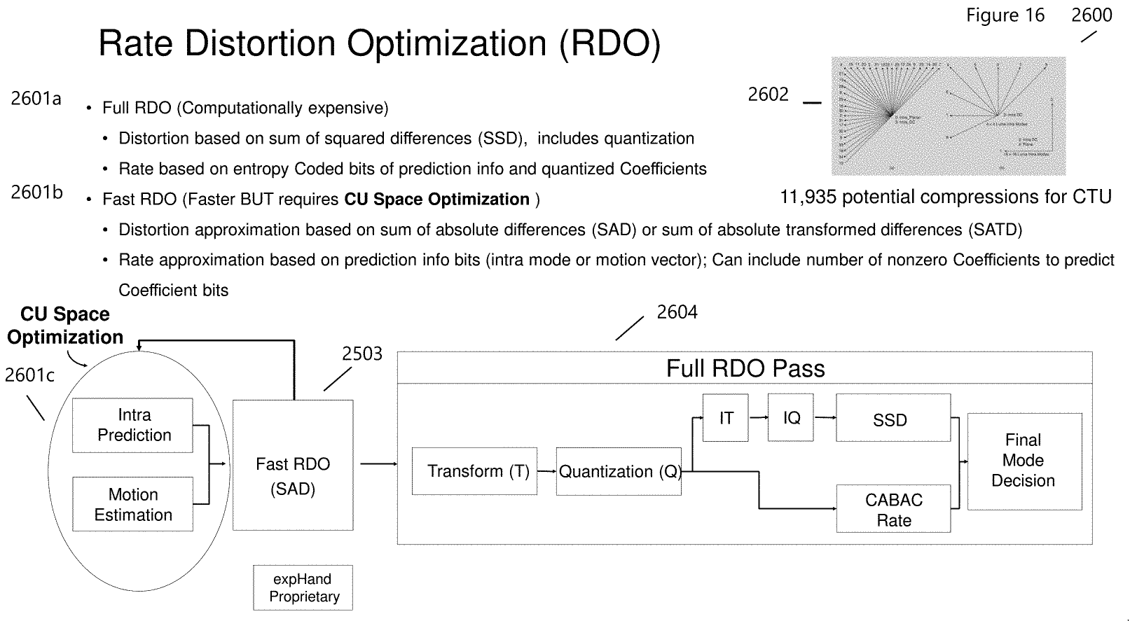

FIG. 16 shows a comparison between a Full (2601a) and Fast (2601b) RDO methodology. In each case, the RDO forms an integral component in compression and transmission of data, as shown in FIGS. 7 (1700) and 14 (2400). The RDcost (2410) estimation requires a full block compression in order to determine the optimal and acceptable Distortion (D [2411]), Bitrate (R [2414]), and Quantization (QP [2413]). For HEVC, there are over 11,935 potential intra-coding compressions (2602). The number of RDO candidates is usually reduced through the utility of a Fast RDO process (2601b), however, the complexity of the compression algorithm remains rather high with most of the computational expense estimating R, as it involves binary arithmetic coding represented. Some efficiencies can be achieved by using SAD (Sum of Absolute Differences) as opposed to SSD (Sum of Squared Differences), and a Rough-Mode-Detection (RMD) process to limit the number of permutations before performing a Full RDO (2601a) process. Note that the Content Gateway Unit (900) and Content/Device utility (135, 145, 125), including user-specific requirements (130, 140, and 120), impact the HyperData Unit 888 through Compression Application Unit 889, and similarly affect the encoding, transmission, and decoding thresholds and convergence parameters.

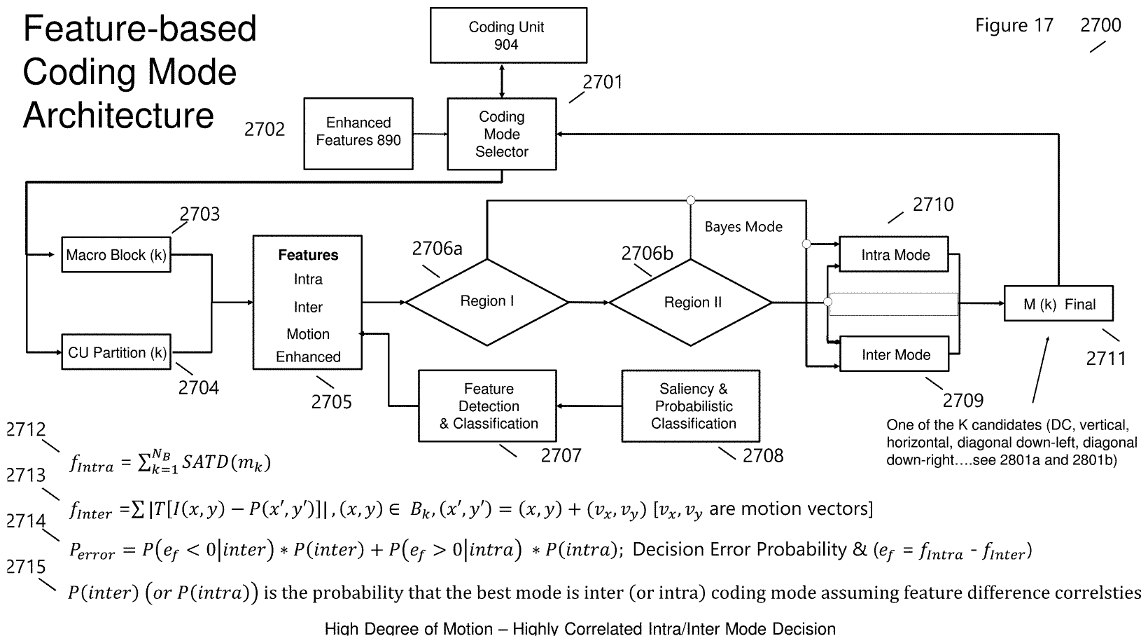

FIG. 17 (2700) shows a Feature-Based Coding Mode Architecture that determines a division between Intra-prediction and Inter-prediction (2705) based upon image features that cascade across scales and resolution as a function of MB (2703) or CU partitioning (2704). The Coding Mode Selector (2701) receives information from Enhances Features (890; HyperData FIG. 9), and after analysis, this resulting mode and probability are delivered to SmartEncoding (904) through networks, threads, or memory (2702) that may be cached, stored, or temporally/spatially utilized as part of an encoding, decoding, or analysis application. Coding Mode Selector (2701) utilizes Coding Databases (905) and Enhanced Feature Detection Unit (890) that contain previous detected and calculated feature parameters, structures, networks, and scales, which can be general (902) or specific (903). These are combined to determine objects types, dynamics, and saliency components used within the SmartData™ representation and HyperData Compression™. Features (2705) can be used to estimate temporal and spatial correlations, as well as motion estimation. Motion estimation is limited by a causal representation (object-background-frame motion are constrained), including translational and rotational dynamics. ROI (Region of Interest) detection and dynamics are aided by modeling and the use of real-world activity analysis as described in Independent Activity Analysis™. These technologies not only support encoding, transmission, and decoding but provide a basis and reference frame for Artificial Reality (AR) and Virtual Reality (VR).

The morphological variations in features are determined and categorized using the Feature Engineering Unit (894) and the Enhanced Features Detection Unit (890), which subsequently reduce the computational complexity of source coding, by detecting the most probable intra and inter partitions (CU or MB). Saliency and Probabilistic Classification (2708) determines regions of image complexity that captures human attention or focus. Human Visual System (HVS) models, like Saliency, are used by image and video processing experts in the pursuit of developing biologically inspired vision systems. Features from (2705), (2706), (2707), (899-903) form an N-Dimensional Feature Vector Space (NDFVS) that is partitioned into probabilistic regions of deterministic source-coding, and whose partitioning is accomplished through the use of supervised and non-supervised learning algorithms.

High-level coarse grain features and structures are used to determine an initial decision between inter-prediction intra-prediction coding, reducing the computational complexity through early detection. CUs or MB are partitioned into [symbol] regions where l∈ [symbol] and l≤ [symbol] . The [symbol] regions are determined through Machine Learning methods, SmartData, and previous content features (899, 900, 901, 902, 903) and Coding Databases (905). Each [symbol] region represents a particular probability [symbol] which satisfies 0≤ [symbol] ≤1 with [symbol] =0 signifying Inter-Prediction and [symbol] =1 being Intra-Prediction. The partitioning of the probability space is non-uniform and depends highly on the level of complexity and object characterization within the content. Based upon this non-linearity, the SmartEncoder (904) determines an intra region (Region I) [symbol] _{l≤l}_{₁}, a Transition Region (TR) [symbol] ₗ_{_{1≤l}}₁_{_{+Δ}}, and an inter-prediction region (Region II) [symbol] _{l>l}_{₁}_{+Δ}. The values of l₁ and Δ are estimated by the Coding Mode Selector (2701) that receives parameters from Enhanced Features (890), (2707) and (2708).

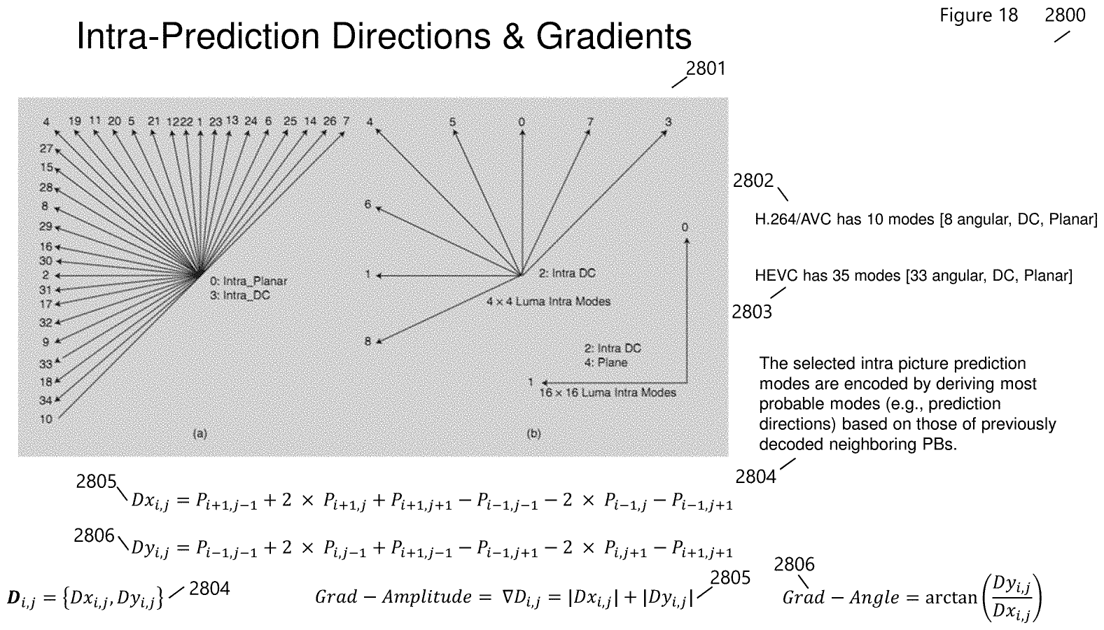

In the simplest representation, the intra-predication Feature Space can be written as fᵢₙₜᵣₐ=Σₖ₌₁^{N}^{_{B}}SATD(mₖ) where mₖ=argmin SATD(m), SATD (m)=Σ|T[I(x,y)−P(x,y)], T(⋅) is the Hadamard transform, I(x,y) and P(x, y) are pixels of the k^{th} block of the current MB or CU. If fᵢₙₜᵣₐ is small, the associated probability is such that intra-prediction best represents the optimal process. The potential mode, m={m₀, m₁, m₂, m₃, m₄}, corresponds to {dc, vertical, horizontal, diagonal-down-left, diagonal-down-right}. There are 10 intra-prediction modes as part of the H.264/AVC standard however for coarse level partitioning we choose 5 as represented in the modes above. The number of modes is determined by the initial complexity of each image, block, or coding unit depending on the target requirements. The complete specification of the intra-prediction Feature Space would include al 10 modes; however, a heuristic scaling is used to truncate the pixel directional analysis, for modes that may or may not be represented within the 5 modes (2711). This level of generalization, variable mode selection from (2801b) is supported through adaptive mechanics realized through feature detection and saliency calculations, and more broadly the inclusion of HyperData Unit (888) analysis. For HEVC codecs, the standard significantly increases the number of potential intra-modes from 10 to 35, as shown in FIG. 18 (2801a), resulting in an additional 11,935 potential compressions that increase the computational time necessary for content source-coding. By decreasing the intra-prediction modes, several direct benefits are obtained such as (1) source-coding times decrease, (2) spatial redundancy is removed, (3) storage space is decreased, and (4) transmission bandwidth is decreased, (5) decoding resources are decreased, and (5) the consumer experience is ultimately improved. CU or MB Space Optimization (2601c) significantly and positively impact the coding.

Motion vector calculations used in inter-prediction can be summarized as (1) detection of stationary blocks, (2) determination of local motion activity, (3) detection of search center, and (4) local motion search around the center using a diamond search algorithm for fast block motion estimation. There are several methods in determining Block-Matching Motion Estimation (BMME) such as (1) a low-quality Three-Step Search (TSS), (2) a medium quality Four-Step Search (FSS), and (3) Directional Gradient Descent Search (DGDS) and more. For the inter-prediction Feature Space, a Diamond Half-pel Hexagon Search (DHHS) algorithm is used to determine the Motion Vector (MV). The inter-prediction Feature Space can be written as fᵢₙₜₑᵣ=Σ|T[I(x, y)−P(x′,y′)]| where (x′,y′)=(x, y)+(vₓ, v_{y}) with (vₓ, v_{y}) as the MV. I(x, y) and P(x′, y′) are pixels of the current and predicted CU (or MB), respectively.

The NDFVS ( [symbol] -Dimensional Feature Vector Space) is partitioned into ( [symbol] ) regions, which are then grouped into 3 principal regions as described above: Region I, TR, Region II based upon grouping probabilities ( [symbol] ). The grouping error or erroneous mode assignment is represented as e_{f}=f_{Intra}−f_{Inter} where P(e)=P(e_{f}<0|Inter)·P(Inter)+P(e_{f}>0|Intra) P(Intra) with P(Intra) [or P(Inter)] is the probability that the best mode is intra [or Inter] coding mode. The value of l₁ and Δ are optimized based upon ML, SmartData, Coding Databases (905), Coding Mode Selector (2701), Feature Databases (899, 900, 901, 902, 903), f_{Intra}, and f_{Intra}, so as to reduce P(e). Using a Coarse-Grid approach [Reduced Mode Detection] and incorporating CU (or MB) Space Optimization (2601c) for a Fast RDO, and then a Full RDO (2604), once the parameter space has been reduced significantly improves the coding, transmission, decoding, and perceived video quality.

As mentioned earlier, Directional Gradient Descent Search (DGDS) are used in pre-processing of intra-prediction modes, reducing the optimal number of modes that provide the best coding based upon bitrate, distortion, quantization, and user perception. The pre-processing supports the Coding Mode Selector (2701) in selecting, reducing, or increasing the number of directions within the intra-predictive or inter-predictive CU (or MB) estimation. FIG. 18 (2801) shows a comparison between the intra-mode standards between H.264 (2802) and HEVC (2803). The numbers next to the mode directions (2801a) and (2801b) show the priority order in the selection, and all have a defined direction and angle. Gradient vectors (2804) are represented in terms of Gradient-Amplitudes (2805) and Gradient-Angles (2806) and can be mapped to the mode directions in both H.264 and HEVC (H.265) standards. The gradient information is similarly used to determine the intra-prediction depth for the CU partitions (or MB resolution). FIG. 19 (2900) shows the Intra-Prediction Depth Decision Architecture with Features. The process starts with a Rough Mode Decision (RMD) that selects the best N candidate mode that is tested through the absolute sum of Hadamard Transformed coefficients of the residual signal. A reduced number of modes are selected that either are determined through the SmartEncoder (904) that represent a specific thresholding based upon previous databases (899, 900, 901, 902, 903, 905) or are defaulted to baseline values and are as follows: [(4×4, 17), (8×8, 34), (16×16, 34), (32×32, 34), (64×64, 5)] that is transformed into either [(4×4, 9), (8×8, 9), (16×16, 4), (32×32, 4), (64×64, 5)] for Baseline-RMD or [(4×4, K_{4×4}), (8×8, K_{8×8}), (16×16, K_{16×16}), (32×32, K_{32×32}), (64×64, K_{64×64})] for Modified-RMD (MRDM).

Enhanced Feature Statistics (2902a), Smart Feature Statistics (2902b), Pixel Gradient Statistics (2902c), and ML Features Statistics (2902d) are used to calculate the dominant direction of each PU. Pixel Gradient Statistics (2902c) are determined through the application of vertical and horizontal kernels, from Gaussian (3101) to Sobel and Prewitt Operators. These operators are used in edge-detection for video and image processing, including Convolutional Neural Networks. Utilizing the determine modes from RMD (2901), pixel gradients magnitudes and angles (2908a) within each PU is calculated and then binned within either HEVC or H264 intra-prediction documented angles (2801a or 2801b, respectively). A gradient-mode histogram is generated for each PU as a function of the angular modes of 33 (2803) and/or 8 (2802) intra-prediction directions by adding the Grad-Amplitudes (2908b) [note that for both H.264 and HEVC both the DC and Planar modes do not represent angular directions and are always used as two candidate modes]. Several modes, m_{g}, are then selected from the largest sum of Grad-Amplitude (2908c). The number of m_{g} modes depends on several key factors such as gradient amplitudes and directions, vector kernels (3402), Enhanced (2902a) and Smart (2902b) Features, and Machine-Learning Features (2902d) that are obtained through detailed capture, analysis, and engineering to create methods and databases (899,900, 901, 902, 903, 905) with varying spatial and temporal sensitivity. The m_{g} modes numbers are also sensitive to the Feature Space as described in FIG. 17 (2700) with the Region I ( [symbol] _{≤l}_{₁}), Transition Region ( [symbol] _{<l≤l}_{₁}_{+Δ}) and an inter-prediction Region II ( [symbol] _{≥l}_{₁}_{+Δ}), providing further information concerning image complexity.

Statistical noise is introduced through the differentiation and averaging process whereby larger PUs sizes (64×64 to 16×16) have less noise than smaller PUs (8×8 to 4×4). This results in a need for more modes at smaller PU sizes resulting in: (a) Rough Mode Detection having [(4×4, m_{rmd4×4}), (8×8, m_{rm8×8}), (16×16, m_{rma16×16}), (32×32, m_{rm32×32}), (64×64, m_{rmd64×64})] where m_{rmd4×4}=f(RMD_{4×4}|mg), m_{rm8×8}=f(RMD_{8×8}|m_{g}), m_{rmd16×16}=f(RMD_{16×16}|m_{g}), m_{rmd32×32}=f(RMD_{32×32}|mg), m_{rmd64×64}=f(RMD_{32×32}|mg), and satisfy m_{rmd64×64}<m_{rmd32×32}<m_{rmd16×16}<m_{rmd8×8}<m_{rdm4×4}. The RDO Transform Decision (2906) uses a similar noise scaling and can be written as [(4×4, m_{rd4×4}), (8×8, m_{rdo8×8}), (16×16, m_{rdo16×16}), (32×32, m_{rdo32×32}), (64×64, m_{rdo64×64})] that typically have smaller correspond values than their RDM PU size mode values. Mode Assessment (2903), as shown in FIG. 19, receives directional modes from the Statistical Directional Mode Analysis (2902). If the number of modes is less than a threshold, a Mode Refinement (2905) process is used to compare the mode to surrounding PUs, which use two neighboring modes, N−1 and N+1, where N is the mode number under consideration. Depending on the RD-cost for each mode, select the mode with the least cost. This is directly sent to the RDO Transform (2906) and selecting the mode with the least cost, the Best Prediction Mode Structure (2907) is calculated. If the Mode Assessment is negative or has multiple modes, RDO Mode Decision (2904) determines the optimal modes, that are subsequently sent to the RDO Transform Decision (2906) module, resulting in the optimal residual quad-tree structure (or MB structure). Three principal steps are involved in the gradient-analysis
1) Select PU
   a. Determine individual pixel gradients (e.g., Convolutional Mask or kernel)
   b. Calculate individual amplitude and angle of the gradient
   c. Determine corresponding intra-mode direction for each pixel (i.e., perpendicular)
   d. Sum each intra-mode direction over all pixels within the PU
   e. Select intra-modes with the largest values as candidate modes
2) Select intra-modes from each PU for rough mode decision (RMD) within the quad-tree
3) Select intra-modes in rate-distortion optimization (RDO) within the quad-tree

The intra-mode value for each of the PUs is determined through the utility of the SmartData Analysis and Processing, which incorporates a collection of machine learning and analytical methodologies, including, kernels and convolutional masks. Generic values are determined through the analysis of video and image databases; however, media and application-specific content may have specific coding depths that provide encoding benefits.

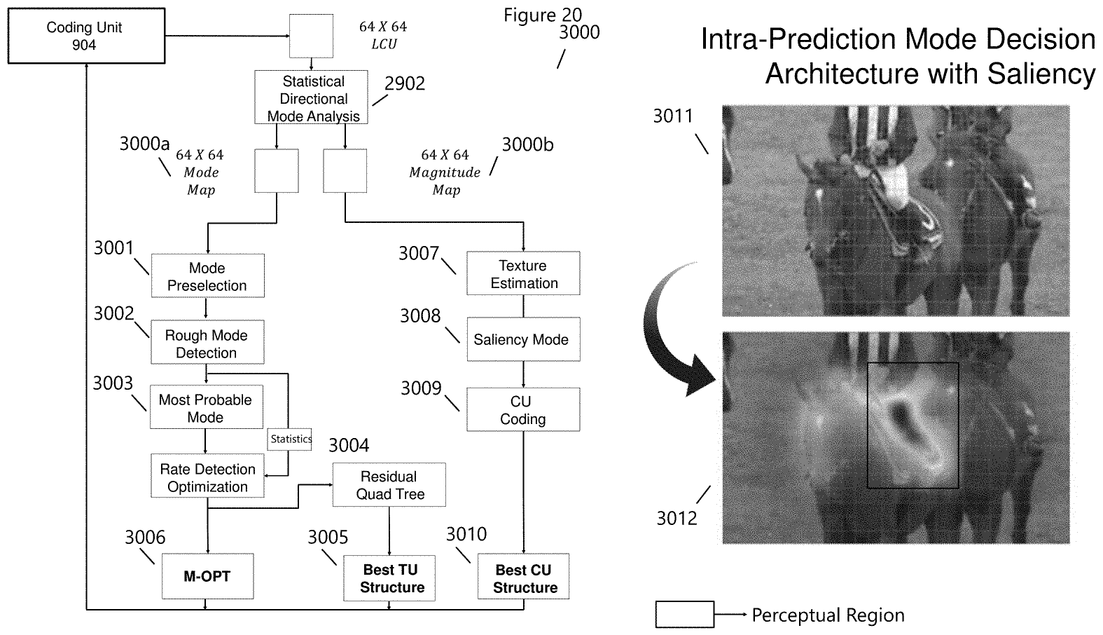

FIG. 20 (3000) incorporates many of the design and architecture features (2902, 3000a, 3001-3006) from FIG. 19 (2900) with the inclusion of a Magnitude Map (3000b) that is used to determine Texture Estimation (3004) providing an early termination in CU Structure through the measurement of texture cascading with human visual perception factors (Saliency Mode 3008). There is a continual trade-off in Lossy Video Transmission between the level of video Distortion (D) and transmission bitrate (R), requiring optimization of encoding and transmission control parameters, as described in FIG. 14 (2400). Limitations in the Human Visual System allows for sub-sampling of the Chroma components (FIG. 10), and a measure of distortion that is not perceptible. As consumer devices and communications are improved, these trade-offs will become more apparent. By integrating visual perception metrics into the encoding process, increase resolution and CU depth can be used, resulting in less distortion in regions of complexity that are perceptible.

As shown in FIG. 20 (3012), saliency detection locates the most conspicuous object (or region) in an image, which typically originates from contrasts of objects and their surroundings, such as differences in color, texture, shape, etc. The detections of salient objects in the images are of vital importance, because they not only improve the subsequent image processing and analyses but also direct limited computational resources to more efficient solutions. In computer vision, based on data processing mechanisms, saliency detection methods are generally categorized into two groups: bottom-up methods and top-down methods. The bottom-up methods are often involved in feature properties directly presented in the environment. They simulate instinctive human visual mechanisms and utilize self-contained features such as color, texture, location, shape, etc. Compared to top-down methods, the bottom-up methods are more attentive, and data-driven, being easier to adapt to various cases, and therefore have been widely applied. With the suitable bottom-up analysis, combined with contextual and personalized information (SmartData and IAA), cognitive and emotional responses can be determined, providing insight into affective media, product placement, education, and more. Similarly, salience coupled with enhanced feature maps for medical and scientific applications (e.g., MRIs, CAT-SCANs, etc), can be utilized to improve human-medical diagnostic through a Top-Down attention direction, using a bottom-up saliency and feature map representation.

Bottom-up methods comprise one of the major branches of saliency detection methods, which focus on low-level image features. Recently, graph-based methods have emerged to apply inter-regional relationships in saliency detection, among which the boundary-based feature is one of the highly effective contributors. Input in the form of video images, each image is progressively subsampled using dyadic Gaussian pyramids, which progressively low-pass filter and subsample the input image, yielding horizontal and vertical image-reduction factors ranging from 1:1 (scale zero) to 1:256 (scale eight) in eight octaves. Each feature is computed by a set of linear “center-surround” operations akin to visual receptive fields within a weaker antagonistic concentric region, making the method sensitive to local spatial discontinuities center-surround is implemented in the model as the difference between fine and coarse scales that comprise stored features information within HyperData Unit (888) and feature databases (899, 900, 901, 902, 903, 905). The first set of feature maps is concerned with intensity contrast; the second set of maps is similarly constructed for the color channels; lastly, the final saliency map is obtained from the local orientation information using oriented Gabor pyramids for angles {0°, 45°, 90°, 135°}. The Gabor filters that are the product of a cosine grating and a 2D Gaussian envelope approximate the receptive field sensitivity profile.

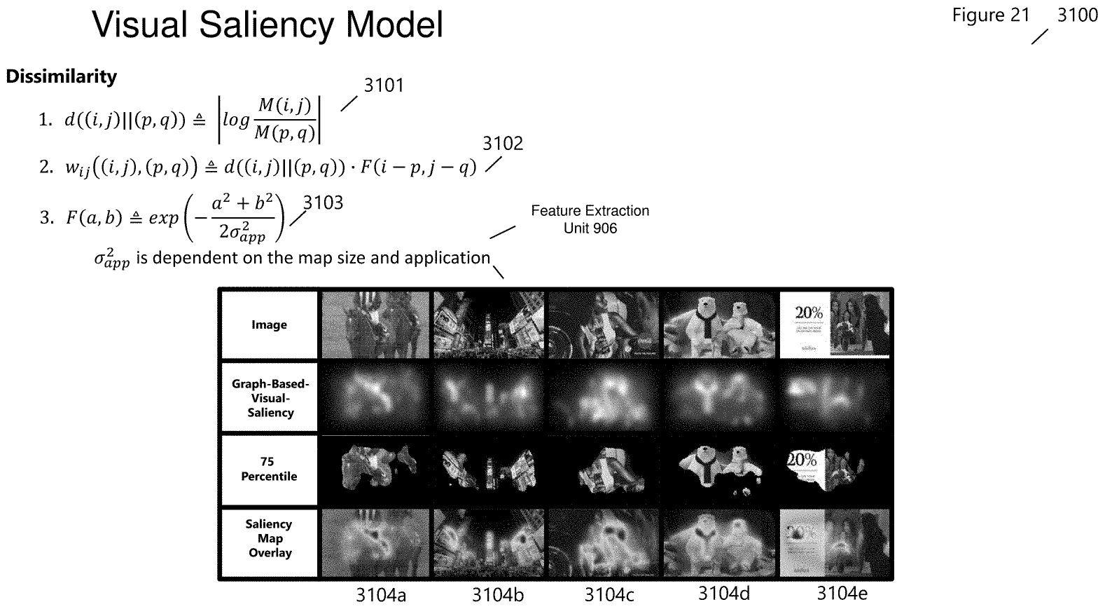

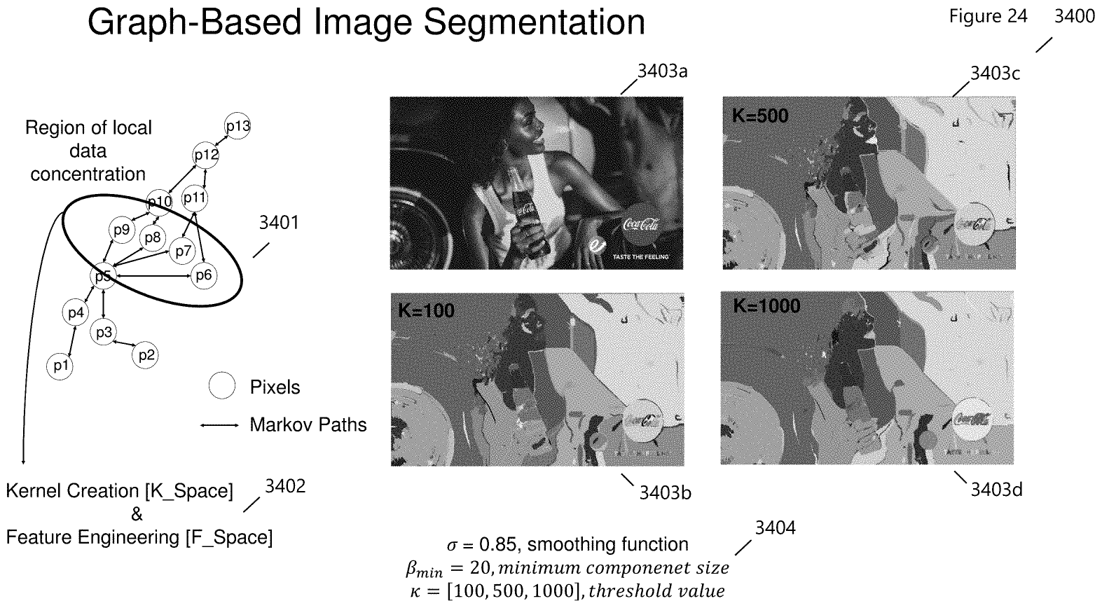

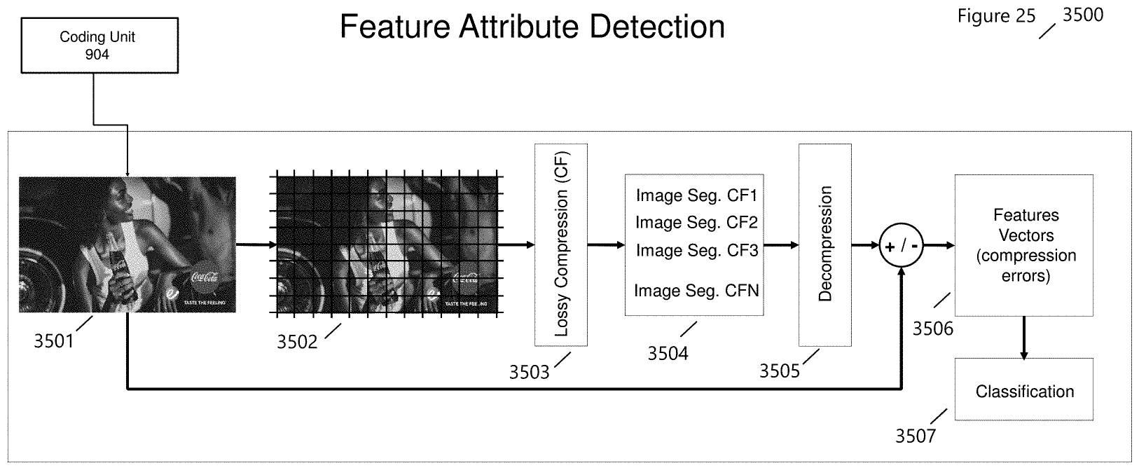

FIG. 21 (3100) shows the results of Visual Saliency Model for several images (3104a-3104e). Images are processed, and regions of interest or focus are shown. Within these Regions-Of-Interest (ROI) distortion should be minimized. Knowing regions of interest, whether static or dynamic, allows for the displaying of critical information, and is used to determine advertising and marketing placement of “call to action” or the expHand Ribbon. These regions are derived through analysis incorporating a fully-connected graph G, obtained by connecting each pixel node (i,j) within the lattice M(i,j) of pixels, with weight wᵢⱼ for each edge from node (i,j) to (p, q) [See FIG. 24, 3401]. A dissimilarity measure d (3101) is used to determine the distance between one and the ratio of two quantities measures on a logarithmic scale. Individual weights (3102) for each edge are smoothed using a Gaussian filter (3103). A Markov chain G is created by normalizing the weights of the outbound edges of each node to 1, and drawing an equivalence between nodes & states, and edges weights & transition probabilities. This process is equally used for the Graph-Based Image Segmentation (FIG. 24, 3400). The equilibrium distribution of this chain, rejecting the fraction of time a random walker would spend at each node/state if he were to walk forever, would naturally accumulate mass at nodes that have high dissimilarity with their surrounding nodes, since transitions into such subgraphs are likely, and unlikely if nodes have similar M values. The result is an activation measure which is derived from pairwise contrast.

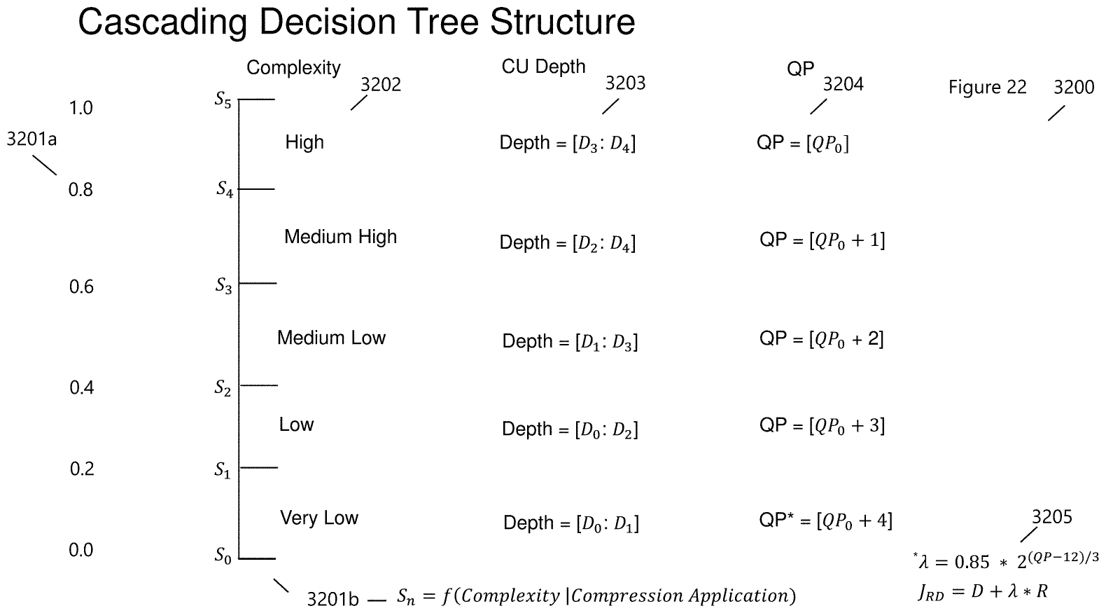

Saliency is a powerful tool to calculate ROI and to help determine the CU, PU, and TU structures that support optimal coding, transmission, and viewing. Cascading Decision Tree Structures (FIG. 22, 3200) are based upon regions of complexity within a CU, Sub-CU, or MB. Complexity factors (3202) range from regions of High Complexity (S₅) to Very Low Complexity (S₀). The complexity level in the simplest form is a function of the compression application (as outlined in FIG. 2, MMC1-S5) and can be represented by 3201b. The partitioning is shown as linear between S₀-S₅, however, the complexity partitioning can be non-linear and depends on the compression application, complexity, Feature Space Partitioning (Region I, Transition Regions, Region II), Statistical Directional Mode Analysis (2902), and more. The CU Depth (3203) and QP (3204) values increase as the saliency complexity increases. CUs with high saliency will attract more visual attention than CUs with low complexity, which can tolerate more distortion. Consequently, QP values increase with complexity to reduce perceived distortion values as described through 3205.

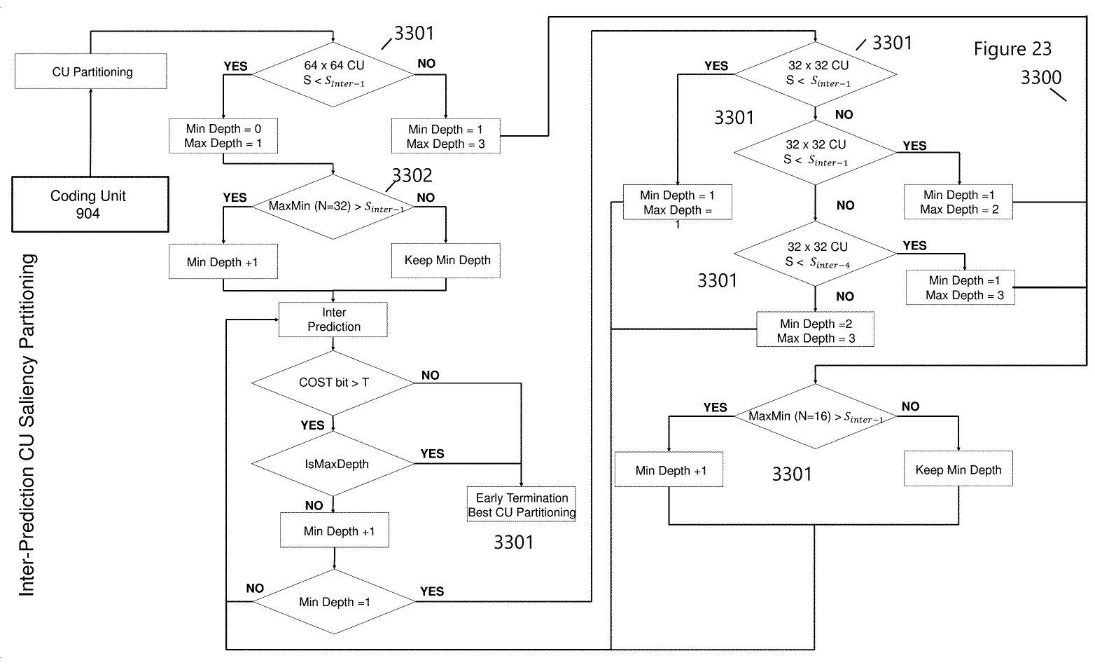

Inter-Prediction can equally benefit from the use of Saliency Mode (3008) as shown in FIG. 23 (3300). Generally speaking, the maximal depth of optimal CU mode is closely related to texture and movements complexity in images. The high complexity means the high level of total intricate texture rather than blocks containing boundaries between foreground objects and background. Using the Cascading Decision Tree Structure (FIG. 3200), an early termination schema can be developed for inter-prediction coding units. FIG. 23 outlines a general control logic utilizing the Saliency (S) threshold measuring the complexity within each CU. As in the case of Intra-prediction partitioning, the separation between complexity transition regions can vary in a non-linear manner depending on video or image complexity. FIG. 22 shows a linear separation (Very Low to High Complexity values (S₀-S₅)) for intra-prediction, and it is similar for inter-prediction and inter-prediction thresholds used in FIG. 23. The non-linear partition supports a generalized improvement in CU partitioning and early termination of CU depth levels. FIG. 23 differentiates the saliency thresholds by Sᵢₙₜₑᵣ₋ᵢ where varies for partition levels. For convenience only 5 partitions are displayed in FIG. 22, however, there are no restrictions on the number of partitions.

Image segmentation uses two different kinds of local neighborhoods in constructing the graph, and as implemented (FIG. 24), performs image segmentation in linear-time making it ideal for real-time streaming applications. An important characteristic of the graph-based image segmentation method is its ability to preserve the details in images with low-variability while ignoring details in regions of high-variability. This method is capable of capturing perceptually important groupings or regions, reflecting global regions of non-local characteristics suitable for enabling image recognition, indexing, figure-ground separation, and recognition by parts. Utilizing a pairwise region comparison to determine a predicate is the basis of this segmentation process, graph-based formulation of the segmentation problem.

An undirected graph G=(V, E) with vertices V and edges E, having weights wᵢⱼ ∈E and wᵢⱼ as the weight of the edge connecting (i,j) vertices where wᵢⱼ≥0. wᵢⱼ is a non-negative measure of the dissimilarity between neighboring elements vᵢ and vⱼ, measuring the dissimilarity between pixels connected by edges (e.g., the difference in intensity, color, motion, location or some other local attribute). A segmentation S is a partition of V into components whereby a connected component C represents edges E′⊆E. These subsets of E, represented by E′, are segmented pixels. The elements in a component Cₖ are similar, while elements differ or are dissimilar when comparing different components (i.e., Cₖ and Cₖ₊₁, where k is the component index). This means that edges between two vertices in the same component should have relatively low weights, and edges between vertices in different components should have higher weights. We define a state that predicts if there is evidence for a boundary between two components in a segmentation. This is based on measuring the dissimilarity between elements along the boundary of the two components relative to a measure of the dissimilarity among neighboring elements within each of the two components.

The result compares the inter-component differences to the within component differences and is thereby adaptive with respect to the local characteristics of the data. The internal difference I of a component C is defined as the largest weight within the minimum spanning tree of the component, MST(C, E) [Minimum Spanning Tree]

$$I ( C ) = \frac{max}{e ∈ M S T ( C , E )} w ( e )$$

Where the difference between the two components (C₁, C₂) is defined as the minimum weight connecting the two components, D

$$D ( {C}_{1} , {C}_{2} ) = \frac{min}{{v}_{i} ∈ {C}_{1} , {v}_{j} ∈ {C}_{2} ( {v}_{i} , {v}_{j} ) ∈ E} w ( ( {v}_{i} , {v}_{j} ) )$$

A segmented boundary is labeled TRUE when the difference between the components D is larger than the internal difference I as

$$D ( {C}_{1} , {C}_{2} ) = \{ \begin{matrix}True , & if D ( {C}_{1} , {C}_{2} ) > {I}^{′} ( {C}_{1} , {C}_{2} ) \\ False , & Otherwise\end{matrix}$$

where I′ is the minimum distance that incorporates a threshold, taking into consideration the size of the component I′(C₁, C₂)=min((C₁)+τ(C₁),I(C₂)+τ(C₂)): τ(Cᵢ)k/|Cᵢ|:k set scale of observation, resulting in segmentation of images, the creation of image-object kernels and feature attributes of object detection, classification, and naming. A Graph-Based Visual Saliency method is disclosed below in the next section, which expands the focus of segmentation, to image attention or “pop-out” features whereby (1) coding-tree depth is increased in visual perceptible image areas, while (2) coding-tree depths are reduced in areas of less complexity and in non-perceptual image areas. The results decrease coding times, data size, and bandwidth requirements.

Several benefits are realized through the use of HyperData Compression™ within the SmartPlatform™. The first benefit provides the ability to embedded securitized information (steganography) using SmartMedia that does not alter the content and is not observable to an individual. The second is securitized communications using cryptographic methods enabled by Smart Security™. The third benefit from HyperData™, as described within this invention, allows for the detailed analysis of content, as described in FIG. 2 (MMC1-S5), from the detection of features to the detection of embedded content and image tampering. Detecting whether an image has been modified is necessary for authenticity, copyright to SmartMedia™ application robustness and QoS (Quality of Service). Forensic applications identify content that has undergone a local or non-local (global) alteration (e.g., copy-move forgeries, splice forgeries, inpainting, image-wise adjustments [resizing, histogram equalization, cropping, etc.] and many more). FIG. 25 (3500) outlines an architecture of Feature Attribute Detection used in content forensic analysis. Each image, from the SmartEncoder (904) is divide an image into N different patches of 64×64 pixels (3502). Each patch is compressed with varying quality Q (3503), using a lossy compression that results in different compression factors (new/original) (3504). The patch is decompressed producing multiple image patches. The error is calculated for each compression factor Q, between the original patch and the compressed-decompressed patch using the Mean Square Error (MSE) (3506). Based on the errors for each compression factor Q, and for each patch, a features vector Vᵢ=[Fᵢ₁, Fᵢ₂, . . . , F_{iQ}] and F_{iQ}=MSE(Xᵢ,Y_{iQ}) producing

$$V = [ \begin{matrix}{F}_{11} & … & {F}_{1 Q} \\ ⋮ & ⋱ & ⋮ \\ {F}_{N 1} & … & {F}_{NQ}\end{matrix} ]$$

The matrix V is then used as part of a SmartData Machine Learning System (i.e., including supervised or non-supervised classification method like SVM, KNN or KMEANS) to classify a query image as TP (true Positive) or TN (True Negative) for tampering (3507).

Digital forensic techniques use features designed by human intervention that are employed to detect the tampering and manipulation of images, however, their performance is dependent on the differentiation of these features among original, tampered, and modified images [Feature Extraction Unit 906, Feature Attribution Detection 3500, and SmartData™]. The SmartData Processing Architecture contains Advanced Statistical Analytics, Machine and Deep Learning, and Strong AI and is uniquely positioned to detect tampering and image authenticity. By combining HyperData™ (888) within the SmartPlatform™, complex algorithms incorporate new and advanced feature detection analysis in concert to address tampering [SmartData's Deep Learning utilizes artificial neural networks by stacking deeper layers. Deep learning models include Deep Neural Networks (DNNs), Convolution Neural Networks (CNNs) using convolution and pooling for image processing, and Recurrent Neural Networks (RNNs).

Figure (30) shows a representative CCN (4001) that is used for tamper detection using a high pass filter to acquire hidden features in the image, rather than semantic information (4002). The convolutional layer is composed of 2 layers having maximum pooling, ReLU activation, and local response normalization. The fully connected layer is composed of 2 layers. For the experiments, modified images are generated using median filtering, Gaussian blurring, additive white Gaussian noise addition, and image resizing for 256×256 images. Quantitative performance analysis is performed to test the performance of the proposed algorithm. The input layer is the set of input units. It is a passage through which pixels of an image for learning are entered. Its size is related to the number of image pixels [7]. The convolutional layer consists of various convolution filters. Across the convolutional layer, the result values are passed to the next layer in a nonlinearity. In the pooling layer, the dimensionality of the data is reduced. Next, in the fully-connected layer, the classification is performed according to the learned results. Multiple fully connected layers can be stacked, Drop-out can be applied between each layer to prevent over-fitting or underfitting. Finally, the output layer is learned to score each class and in general softmax function is used. In particular, the convolutional layer consists of various combination of convolution, pooling, and activation operations. The computation of convolution in a neural network is a product of a two-dimensional matrix called an image and a kernel or mask. An ensemble approach combines several detection methods to determine the validity and authenticity of each image, video, or content.

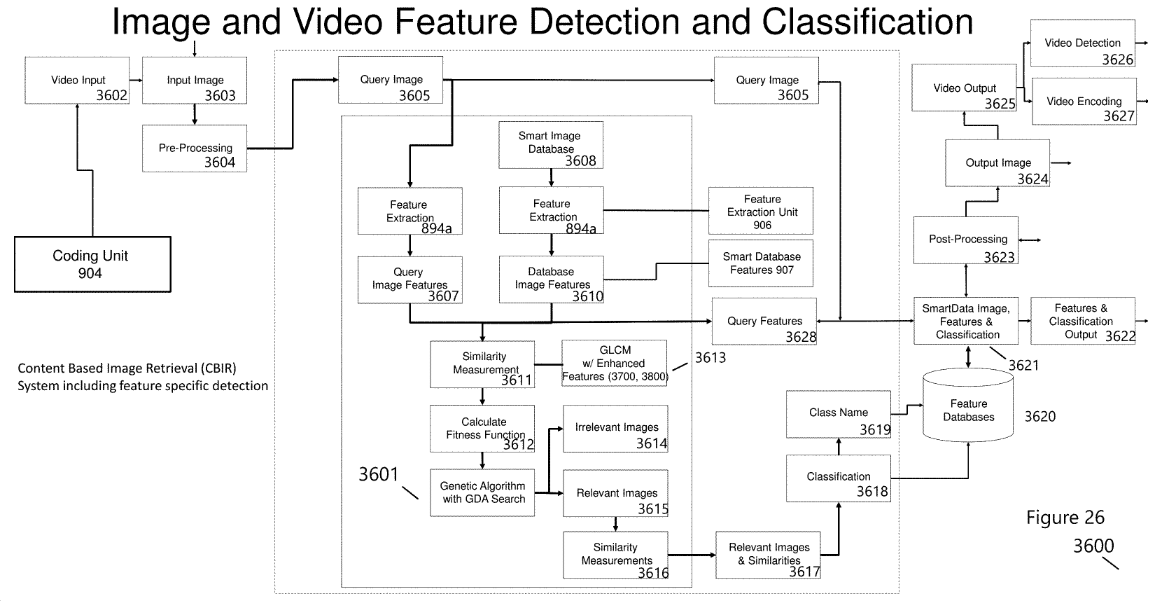

Content-Based Image Retrieval (CBIR) received a lot of attention. The aim of a CBIR algorithm is to determine the images that are related to the Query Information (QI) from the database. The traditional process for image retrieval is performed by describing every image with a text annotation and retrieving images by searching the keywords. This process has become very laborious and ambiguous because of the rapid increase in the number of images and the diversity of the image contents. FIG. 26 (3600) displays an image and video feature detection and classification architecture and method that utilizes genetic algorithms (3601). One of the most commonly used meta-heuristics in optimization problems is the genetic algorithm. Genetic algorithm (GA) is a search algorithm which stimulates the heredity in the living things and is very effective in finding the optimum solution from the search space. In order to enhance the performance of a meta-heuristic such as GA, a local search algorithm is needed to help the GA for exploiting the solution space rather than just concentrating on exploring the search space. The great deluge algorithm (GDA, 3601) is used as a local search algorithm. The great deluge algorithm is an effective way to yield improvements in optimization results from genetic algorithms.

SmartEncoder (904) delivers a video (3602) or image (3603) that is preprocessed (3604). The preprocessing step applies a noise reducing median filter to reduce salt and pepper noise, speckle noise, and edge preservation. The CBIR starts with a query image (3605). Content (1301) is processed through the HyperData™ Unit (888) and SmartData™ Processing Unit, creating Smart Database of Features (907). Feature clustering is one of several classification methods used in feature detection and classification. Clustering impacts data mining, pattern recognition, and machine learning; therefore, various types of techniques for clustering data information have used on numerical information, interval-valued information, linguistic information, and more. Several clustering algorithms are partitional, hierarchical, density-based, graph-based, model-based. In order to evaluate or model uncertain, imprecise, incomplete, and inconsistent information, Single-Valued Neutrosophic Set (SVNS) and Interval Neutrosophic Set (INS) are used. The Neutrosophic clustering algorithm is applied to separate pixels with very near values and to ignore.

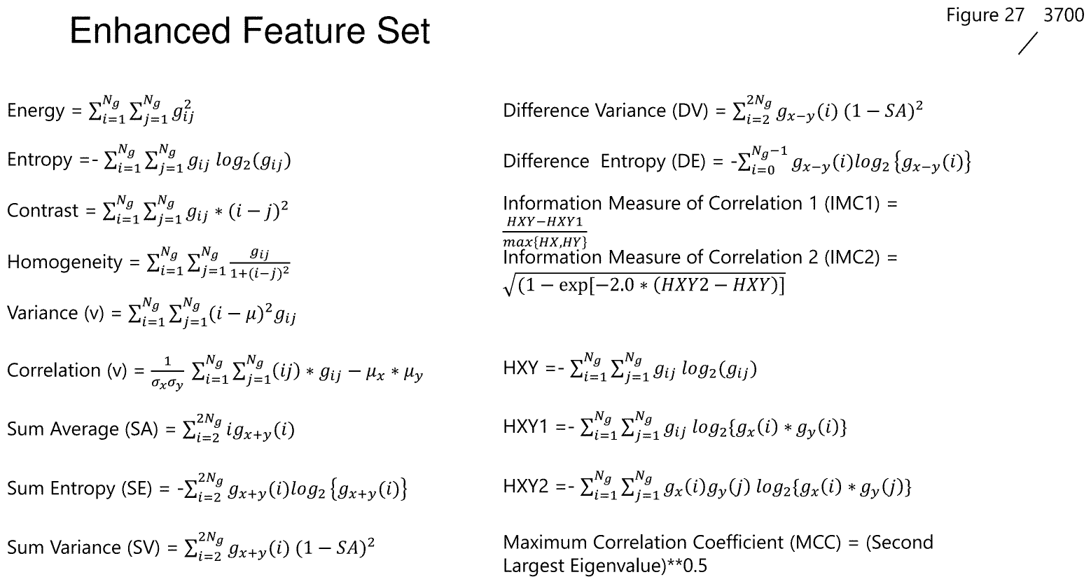

Feature Extraction (894a), for shape features extraction and edge-based shape representation, employs a series of Prewitt, Sobel, Canary, Kernels, and Features-Masks (3402) with the appropriate thresholding (specific or fizzy thresholding parameters) determined by HyperData™. These features provide numerical information about the image, image size, direction, and position of the objects. Similarity Measurements (3611) employ GLCM (Gray-Level Co-Occurrence Matrix) analysis using Enhanced Features (FIG. 27, 28). GLCM is a robust image statistical analysis technique that is defined as a matrix of two dimensions of joint probabilities between pixels pairs, with a distance d between them in a given direction h. Pixel-wise operations as outlined in the Enhanced Feature Set (3700, 3800) are used to evaluate the feature classification. The number of features depends on the image, image complexity, and image content as shown in HyperData™ applications [MMC1-S5]. Highly correlated features are removed so as to increase the performance of the learning and retrieval process. The Genetic Algorithm and GDA Search generates chromosomes, the genes in the chromosomes indicate the images of the database. The chromosome can't contain repeated genes and the genes values depend on the number of database images that will be queried. The features extracted from every image are gathered as a feature set and the set of features from the query image also are extracted. Then each chromosome is subjected to the crossover, mutation (genetic operators) and great deluge algorithm local search in order to generate a new chromosome. The parameter settings of the GA are determined from the Feature Extraction Unit (906), Smart Database Features (907), Smart Image Database (3608), and learned features from Feature Databases (3620). Relevant images (3615) are extracted from the comparison, and similarity measurements are performed to determine the most pertinent image for retrieval.

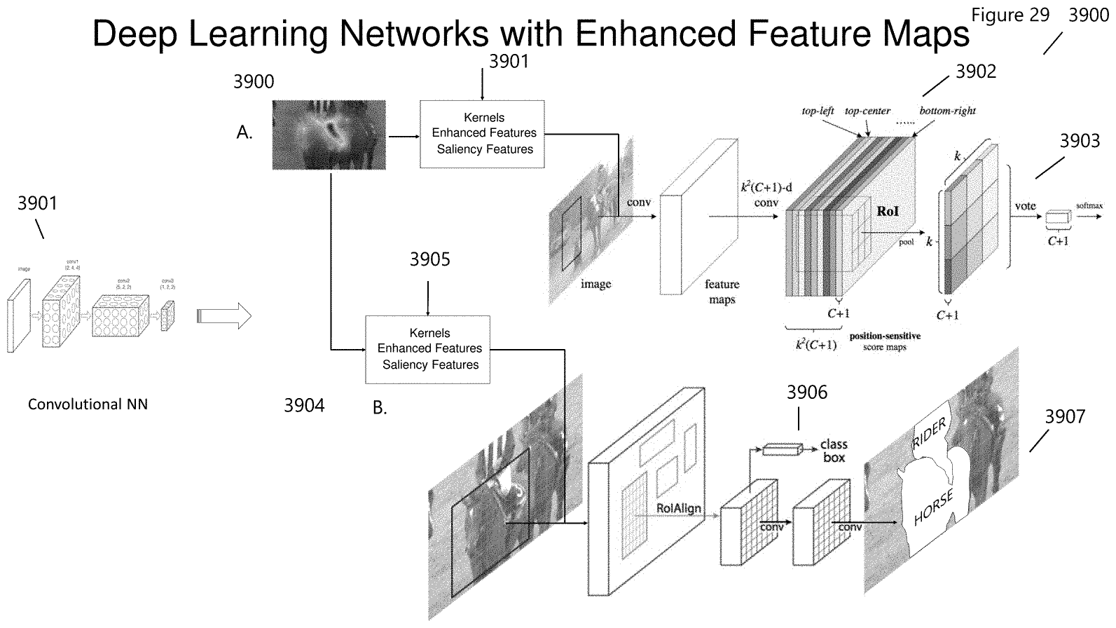

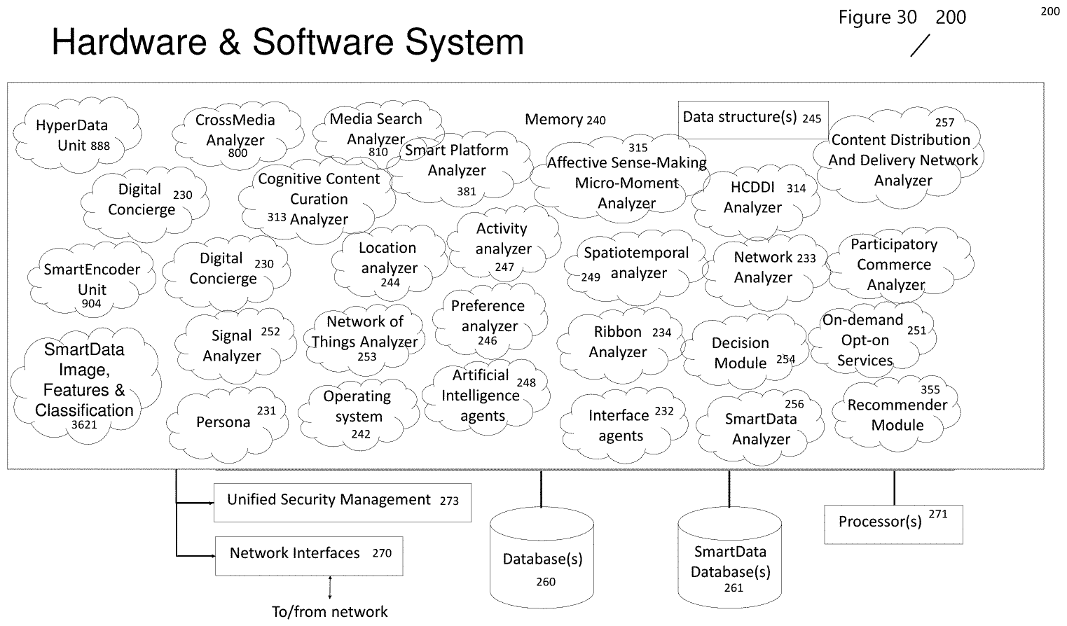

The Similarity Measurement (3617) also determines additional feature information that can be used within the Feature Engineering Unit (894) and Feature Extraction Unit (906), and then can be stored for further utility within the HyperData™ Unit (888) and HyperData™ Coding System Integration (FIG. 3, 1300). Relevant images and their similarities are extracted (3617), Classification (3618) from and Class Name (3619) are determined through SmartData™. The similarities, classification, and names are used within the SmartData Image, Feature & Classification (3621) Unit and deliver component information for other processes within the HyperData™ Unit and SmartPlatform™. As described earlier, FIG. 29 HyperData™ utilized CNN to determine image tampering, as well as Region-Of-Interest determination. The SmartEncoder (904) provides enhanced feature kernels to the CNN (3900, 3902) including Saliency Features (3008), that enable ROI detection (3903), object classification (3906, 3907) and feature detection (890), creation and engineering (894).

FIG. 3 (1300) shows a representative architecture for the Smart Platform that integrates the HyperData™ Unit (888), SmartEncoder™ (904), and an Affective Platform. Users are distributed throughout a hybrid communication and computing network, which and appear/disappear based upon their associated activities, and can process, share, cache, store, and forward personally and or group-secured content with digital key security encryption, enabled by a Unified Security Management (273). SmartMedia™ delivers SmartEncoded™ data, information, and content that may or may not be spatiotemporal user specific. User A (130), with a smart device (135), may contain all-media content (e.g., video, audio, images, print etc.) that can be partial or complete in nature and securely concealed or embedded using an individual or shared SmartEncoder™ (904) that is specified from the HyperData™ Unit (888) and the Hyper-Spatial Affective Sense-Making & Micro-Moment User Digital Information Filter (349). Desired or user-specific content is stored, access, and monitored from (1301). The SmartData Processing Unit (201), coupled with the One-Second-Gateway™ (900), delivers user-desired content that has been compressed using the HyperData™ Unit

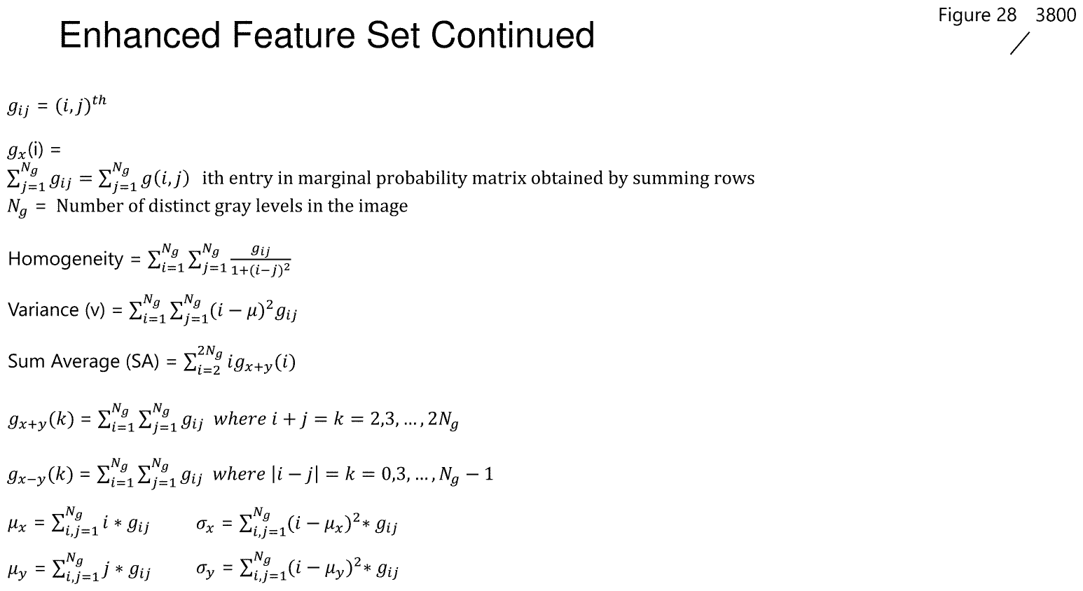

The HyperData™ Unit (888) determines the appropriate compression metric and parameters that provide the best compression ratio based upon distortion and bitrate requirements. Advertising and specialized user information (909) can be encrypted (908) into the content. SmartEncoder (904) used compression specific information, Coding Databases (905), analyzes videos, images, and more, removing spatial and temporal redundancy in order to optimize compression and early-termination of Coding Tree Units (CTUs) or MacroBlocks (MBs). Enhanced features engineering, creation, detection, extraction, and classification are integral parts of this invention and architecture as shown in FIGS. 17-29. The identification and classification of features can be used throughout HyperData Applications as shown in FIG. 2 (MMC1-S5).

The server 200 may comprise one or more network interfaces (210) (e.g., wired, wireless, etc.), at least one processor (220), and a memory (240) interconnected by a system bus (250), as well as a power supply (e.g., battery, plug-in, etc.). Additionally, or in combination server (200) may be implemented in a distributed cloud system. The network interface(s) (210) contain the mechanical, electrical, and signaling circuitry for communicating with mobile/digital service provider (135) (FIG. 3) and/or any communication method or device that enables and supports (synchronous or asynchronous) Smart Platform users (e.g., smart device which can be a smart-phone, tablet, laptop, smart television, wearable technology, electronic glasses, watch, or other portable electronic device that incorporates sensors such as at least one of camera, microphone, GPS, or transmission capability via wireless telephone, Wi-Fi, Bluetooth, NFC, etc.). The network interfaces may be configured to transmit and/or receive data using a variety of different communication protocols. Note, further, that server (200) may have two different types of network connections (210), e.g., wireless and wired/physical connections, and that the view herein is merely for illustration.

The memory (240) comprises a plurality of storage locations that are addressable by the processor (220) and the network interfaces (210) for storing software programs and data structures associated with the embodiments described herein. The processor (220) may comprise hardware elements or hardware logic adapted to execute the software programs and manipulate data structures. An operating system (242), portions of which are typically resident in memory (240) and executed by the processor, functionally organizes the server (200) by, inter alia, invoking operations in support of software processes and/or services executing on the device. These software processes and/or services may comprise a Signal Analyzer (252), Preference Analyzer (246), Location Analyzer (244), Activity Analyzer (247), Spatiotemporal Analyzer (249), Artificial Intelligence Agents (248), Ribbon Analyzer (234), Interface Agents (232), Network Analyzer (233), Brand Connector (231), and Digital Concierge (230), Network of Things Analyzer (253), Decision Module (254), Recommender Module (355), SmartData Analyzer (256), Content Distribution and Delivery Network (257), Market Basket Module (356), On-Demand Opt-on Service (251), Participatory Commerce Module (208), Smart Platform Analyzer (381), Cognitive Curation Analyzer (313), Human-Centric-Digital-Data & Information (HCDDI) Analyzer (314), Content Gateway (900), SmartEncoder (904), HyperData (888), SmartData Image, Features & Classification (3621) that all play critical roles in interpreting and supporting manual, automatic and or arbitration processes as shown in FIGS. 3 (1300), FIG. 9 (1900), and FIGS. 16 (2600)-29 (3900), and as described herein. Note a centralized memory (240) is shown in FIG. 3, alternative embodiments provide for the process to be specifically operated within the network interfaces (210). Another alternative uses a plurality of stand-alone servers, with each server performing steps of single or multiple processes. Signal Analyzer 252, Preference Analyzer 246, Location Analyzer 244, Activity Analyzer 247, Spatiotemporal Analyzer 249, Artificial Intelligence Agents 248, Ribbon Analyzer 234, Interface Agents 232, Network Analyzer 233, Brand Connector 231, and Digital Concierge 230, Network of Things 253, Decision Module 254, Recommender Module 355, SmartData Analyzer 256, Content Distribution and Delivery Network 257, Market Basket Module 356, On-Demand Opt-on Service 251, Participatory Commerce Module 208, Smart Platform Analyzer (381), Cognitive Curation Analyzer (313), Human-Centric-Digital-Data & Information (HCDDI) Analyzer (314), and Affective Sense-Making Micro-Moment Analyzer (315), Content Gateway (900), SmartEncoder (904), HyperData (888), SmartData Image, Features & Classification (3621) all perform multiple analyses utilizing various techniques (A, ML, Deep Learning, EM, GA, NN and others), however each analysis may be performed by a separate process. Each separate process may be performed by a single server or a combination of servers, that may or may not be distributed in the cloud.

Network Analyzer (233) plays a critical role in the Smart Platform architecture and manages the hybrid network communications. Combined with the Smart Platform Analyzer (381), Cognitive Curation Analyzer (313), HCDDI Analyzer (314), and the Affective Sense-Making Micro-Moment Analyzer (315), the Network Analyzer (233) facilitates the communication and delivery, distribution, caching of cognitive content with Ribbonized security, from the Ribbon Analyzer (234). Content Gateway (900), SmartEncoder (904), HyperData (888), SmartData Image, Features & Classification (3621) and the Unified Security Management (273) system.

Illustratively, the techniques described herein may be performed by hardware, software, and/or firmware. It will be apparent to those skilled in the art that other processor and memory types, including various computer-readable media, may be used to store and execute program instructions pertaining to the techniques described herein. Also, while the description illustrates various processes, it is expressly contemplated that various processes may be embodied as modules configured to operate in accordance with the techniques herein (e.g., according to the functionality of a similar process). Further, while the processes have been shown separately, those skilled in the art will appreciate that processes may be routines or modules within other processes.

While there have been shown and described illustrative embodiments that provide for enhancing advertisements sent to users based on location, it is to be understood that various other adaptations and modifications may be made within the spirit and scope of the embodiments herein. For example, the embodiments have been shown and described herein with relation to a user's personal device. However, the embodiments in their broader sense are not as limited.

The foregoing description has been directed to specific embodiments. It will be apparent; however, that other variations and modifications may be made to the described embodiments, with the attainment of some or all of their advantages. For instance, it is expressly contemplated that the components and/or elements described herein can be implemented as software being stored on a tangible (non-transitory) computer-readable medium (e.g., disks/CDs/RAM/EEPROM/etc.) having program instructions executing on a computer, hardware, firmware, or a combination thereof. Accordingly, this description is to be taken only by way of example and not to otherwise limit the scope of the embodiments herein. Therefore, it is the object of the appended claims to cover all such variations and modifications as come within the true spirit and scope of the embodiments herein.

What is claimed is:

1. A method, comprising:
sending a set of hyperdata parameters including all-media content to a compression application unit;
receiving control parameters while accessing previous coding databases, wherein coding databases provide appropriate coding parameters and procedures for the hyperdata application; and
combining feature extraction, feature learning, feature selection, and feature detection to uniquely utilize unique database features to incorporate smart database features.

2. A method, comprising:
receiving a first content from a first device;
applying a hyperdata parameters to the first content;
compressing the first content using the hyperdata parameters into a first compressed content; and
sending the first compressed content to a second device.

3. The method of claim 2, further comprising:
encoding the first compressed content using a coding database to determine appropriate coding parameters and procedures for the hyperdata application.
